(19) United States
(12) Patent Application Publication
(10) Pub. No.: US 2014/0251652 A1
(43) Pub. Date: Sep. 11, 2014

(54) COMMUNICATION CABLE

(71) Applicant: Leviton Manufacturing Co., Inc., Melville, NY (US)

(72) Inventors: Jeffrey Alan Poulsen, Lynnwood, WA (US); Bryan L. Sparrowhawk, Monroe, WA (US)

(73) Assignee: Leviton Manufacturing Co., Inc., Melville, NY (US)

(21) Appl. No.: 14/199,822

(22) Filed: Mar. 6, 2014

Related U.S. Application Data
(60) Provisional application No. 61/774,339, filed on Mar. 7, 2013.

(51) Int. Cl. H01B 7/30; B29C 47/00

(52) U.S. Cl. CPC H01B 7/303; B29C 47/0066; B29C 47/003
USPC 174/113 C; 264/145; 264/177.1

(57) ABSTRACT

Cables including central insulators and/or center separators. Each of at least some of the central insulators includes a first wire channel configured to receive a first wire of a wire pair, a second wire channel configured to receive a second wire of the wire pair, and an intermediate portion positioned between the first and second wire channels. Each of at least some of the center separators includes a longitudinally extending central portion as well as first, second, third, and fourth portions extending outwardly from the central portion. Optionally, the first, second, third, and/or fourth portions may include laterally extending through-holes. Optionally, the central, first, second, third, and/or fourth portions may include an air-filled longitudinally extending channel. Central insulators for use with coaxial cables and cables that conduct three-phase signals are also provided. Methods of forming central insulators are also described.

### CROSS REFERENCE TO RELATED APPLICATION(S)

This application claims the benefit of U.S. Provisional Application No. 61/774,339, titled Communication Cable, filed on Mar. 7, 2013, which is incorporated herein by reference in its entirety.

### BACKGROUND OF THE INVENTION

1. Field of the Invention

The present invention is directed generally to communication cables.

2. Description of the Related Art

Permittivity describes the ability of a material to store electric field energy. For example, in a capacitor, an increased permittivity allows the same charge to be stored by a smaller electric field (and thus a smaller voltage), leading to increased capacitance. In general, permittivity is not a constant value, and may vary with orientation of the material, the frequency of the electric field applied, strength of the electric field applied, humidity, temperature, and other parameters.

The “effective” dielectric constant takes into account the fact that electric fields are not entirely constrained within a single homogeneous substrate (e.g., a printed circuit board). For example, portions of the electric fields may exist in the air around such a single homogenous substrate and the effective dielectric constant is thus a weighted composite of the dielectric constants of all such materials (e.g., the substrate and air) and the electric field strengths presented to those materials.

Return loss is a measure of how well transmitting, receiving and connecting devices and transmission lines are impedance-matched and represents a loss of power resulting from the reflection of power back toward the power source caused by discontinuities (e.g., impedance or refractive index discontinuities) in a transmission line. A match is good if return loss is high, resulting in a lower insertion loss, and indicating that most of the transmitted power is transmitted to the receiver and not reflected back to the source.

A balanced transmission line includes two wires having equal sizes, uniform insulation, and uniform wire spacing, which results in uniform impedances along the length of the balanced transmission line. Structural return loss is a measure of this structural consistency along the length of the cable. A higher structural return loss value indicates uniformity and the resultant improvement in signal delivery performance.

A signal may be transmitted on a parallel pair of bare wires that are not coated with insulation, assuming they can be physically held in place. In such a system, an electric field (or E-field) extends between the wires and travels through only the air. The dielectric constant of air is about one. In such an arrangement, the E-field is most concentrated in a region positioned directly between the wires. Air, however, is incapable of physically holding the wires in place thereby creating a need for other dielectrics with suitable mechanical properties, but perhaps less suitable dielectric properties, than air. Improvements in dielectric properties (such as lower loss and lower dielectric constant parameters) of the dielectric material, especially in the field-intense region directly between the wires, may improve the performance of the transmission line. Further, the concentrations of the electric field may be altered by changing the shape of the material(s) that surround the wires. More specifically, removal of structural dielectric material from the field-intense regions and allowing air (gas, vacuum, etc.) to exist primarily in those regions may be beneficial to the nature of the composite dielectric's affect upon the transmission line's performance.

FIG. 1A depicts a lateral cross-section of a conventional communication cable 10A that includes eight elongated wires “W-1” to “W-8” divided into four wire pairs “P1” to “P4” and surrounded by an outer cable jacket 16. For ease of illustration, the pair “P1” will be described as including the wires “W-4” and “W-5,” the pair “P2” will be described as including the wires “W-1” and “W-2,” the pair “P3” will be described as including the wires “W-3” and “W-6,” and the pair “P4” will be described as including the wires “W-7” and “W-8.” It is desirable to position the wires of each of the pairs “P1” to “P4” as close to one another as possible. Each of the pairs “P1” to “P4” is typically used to transmit a differential signal. Typically, the wires of each of the pairs “P1” to “P4” are twisted together to form a twisted wire pair.

Optionally, the cable 10A may include a longitudinally elongated center separator 18 configured to separate the pairs “P1” to “P4” from one another. In the embodiment illustrated, the center separator 18 has a cross-shaped cross-sectional shape. Generally cross-shaped center separators, such as the center separator 18 illustrated in FIG. 1A, have four outwardly extending dividers or vanes “D-1” to “D-4.” The vanes “D-1” to “D-4” are solid and substantially planer; however, the center separator 18 may have a longitudinally twisted shape or be configured to be twisted so that the pairs “P1” to “P4” may be twisted together in accordance with a conventional cable lay arrangement.

The wires “W-1” to “W-8” are substantially identical to one another. Typically, each of the wires “W-1” to “W-8” is constructed from a conductor 20 (e.g., copper) surrounded circumferentially by an insulating jacket 22 (e.g., plastic insulation) that has a higher dielectric constant than air. As illustrated in FIG. 1A, the insulating jacket 22 applied to each of the wires “W-1” to “W-8” typically has a different color and/or pattern so each wire is identifiable.

The pairs “P1” to “P4” are substantially identical to one another. For each of illustration, only the first pair “P1” will be described in detail. When the wires “W-4” and “W-5” of the first pair “P1” are positioned adjacently such that the wires “W-4” and “W-5” touch one another lengthwise, the E-field traverses the insulating jackets 22 and extends between the conductors 20 of the wires “W-4” and “W-5.” The E-field includes paths that extend directly between the conductors 20 of the wires “W-4” and “W-5,” and travel through only the insulating jackets 22 of the wires “W-4” and “W-5.” The E-field also includes curved paths between the conductors 20 of the wires “W-4” and “W-5” that travel through both the air (which has a lower dielectric constant than the insulating jackets 22), and the insulating jackets 22 of the wires “W-4” and “W-5.” This causes the electric field to be more concentrated in the region directly between the conductors 20 of the wires “W-4” and “W-5” (where the paths extend only through the insulating jackets 22).

FIG. 1B depicts a lateral cross-section of another conventional communication cable 10B. Like reference numerals have been used to identify like components in FIGS. 1A and 1B. As mentioned above, the pairs “P1” to “P4” are substantially identical to one another.

To help reduce the concentration of the E-field between the adjacent conductors 20 of the wires of the pairs “P1” to “P4,” a different central insulator 24 (e.g., a septum strip) having a low dielectric constant may be positioned between the wires of each of the pairs “P1” to “P4.” For example, the central insulator 24 is positioned between the wires “W-4” and “W-5” of the pair “P1.” By including the central insulator 24, the insulating jackets 22 surrounding the conductors 20 of the wires of the pairs “P1” to “P4” may be thinner. Examples of wires with central insulators include zip-cord and twin-lead. Optionally, each of the pairs “P1” to “P4” may be surrounded by an insulating outer covering 26.

Air bubbles (e.g., air bubbles 34 illustrated in FIG. 2D) may be introduced into the insulating jackets 22 and/or the central insulator 18. This process is often referred to as “foaming.” Because air has a lower dielectric constant than the material(s) used to construct the insulating jackets 22 and the central insulator 24, the air bubbles lower the aggregate dielectric constant of these structures. Unfortunately, the air bubbles are often non-uniformly distributed in the insulating jackets 22 and/or the central insulator 24 and increase the compressibility of one or more of these structures. Foaming can also be an expensive process, increasing the costs of producing the wires “W-1” to “W-8” and/or the cables 10A (see FIG. 1A) and 10B.

Unfortunately, conventional wires typically lack uniformity along their lengths. This causes imbalance and/or changes in return loss (which may be repetitive) along a wire pair. Examples of non-uniformities commonly found in wire pairs within a conventional cable include eccentricities (where the conductor 20 is not centered inside the insulating jacket 22 as illustrated in FIG. 2A), different or varying compression moduli (as illustrated in FIG. 2B), different or varying stiffness (where a first wire 30 may wrap around a second wire 32 as illustrated in FIG. 2C instead of the wires being twisted together uniformly), different or varying dielectric constants (which may be caused e.g., by different coloration, the inclusion of the air bubbles 34 in only one of the wires as illustrated in FIG. 2D, and the like), and inconsistent foil wrap space.

In eccentric wires (see FIG. 2A), both the distance between the conductors 20 and the effective dielectric constant vary along the length of the wires. This wreaks havoc with structural return loss. The irregularities in the air bubbles 34 (see FIG. 2D) injected into the insulating jackets 22 may cause the wires to perform as if the wires are eccentric.

Different or varying compression moduli (see FIG. 2B) may cause variations in the pliancy of the insulating jackets 22 that causes variations in the spacing between the conductors 20. Variations in pliancy may be made worse by the injection of the air bubbles 34 (see FIG. 2D). Further, each of the wires may have a different pliancy (referred to as “asymmetric pliancy”) which may negatively affect balance and thus cause modal coupling. Injecting too many air bubbles (to thereby lower the dielectric constant and/or cost) will make the insulation as pliant as a sponge, which will cause the air bubbles to collapse and position the conductors 20 closer together.

Different or varying stiffness (see FIG. 2C) may be caused by differences in the annealing, alloy composition, or hardness of the insulating jackets 22 used to construct the wires “W-1” to “W-8” (see FIGS. 1A and 1B).

In short, if the insulating jackets 22 surrounding the conductors 20 are non-uniform, the wires “W-1” to “W-8” (see FIGS. 1A and 1B) will not be balanced. Unfortunately, it is much more difficult for a network interface controller (“NIC”) (not shown) to compensate for multiple changes in line impedance (that cause “structural return loss”) than it is for the NIC to correct for a mismatched impedance that is consistent along a communication link.

Returning to FIG. 1B, to help ensure the wires “W-1” to “W-8” have uniform insulating jackets 22 surrounding the conductors 20, and the central insulator 24 has uniform properties along its length, the insulation (both the insulating jackets 22 and the central insulator 24) must be applied to both wires of each of the pairs “P1” to “P4” at the same time. Typically, the insulating jackets 22 and the central insulator 24 are coextruded with the wires of each of the pairs “P1” to “P4” to ensure uniformity between the wires of each of the pairs “P1” to “P4.”

Returning to FIG. 1A, cables configured for high-speed data communications (such as Category 6 cables, Augmented Category 6 cables, and the like), typically include the center separator 18, which provides physical separation between the pairs “P-1” to “P-4” and helps reduce internal crosstalk between the wires “W-1” to “W-8.” The center separator 18 is often constructed from an insulating plastic material, such as polyethylene (“PE”), or flame retardant polyethylene (“FRPE”).

In a conventional cable, such as the cable 10A depicted in FIG. 1A, the center separator 18 may be extruded separately from other components of the cable 10A and added to the cable 10A during a cabling process. During the cabling process, the pairs “P-1” to “P-4” may be spread apart (or branched) and the center separator 18 inserted between them. The pairs “P-1” to “P-4” rest against and contact the center separator 18.

Because the center separator 18 physically contacts the pairs “P-1” to “P-4” along the length of the cable 10A, electrical properties (such as the dielectric constant and dissipation factor) of the center separator 18 impact the electrical performance of the pairs “P-1” to “P-4.” The performance of the pairs “P-1” to “P-4” is also governed by many other factors including the dielectric constant and dissipation factor of other dielectric materials in close proximity to the conductors 20, including, for example, the insulating jackets 22, and air-filled voids (e.g., foil wrap space) in the cable 10A. The electrical properties of each of these components weighted by the proximity of each to the conductors 20 yields an overall effective dielectric constant and dissipation factor that is “seen” by the pairs “P-1” to “P-4.” The lower the effective dielectric constant and dissipation factor, the less attenuation and the higher a velocity factor (represented by “Vp”) is experienced by the pairs “P-1” to “P-4” in the cable 10A.

Less attenuation is typically preferred. This is especially true for shielded and discontinuously shielded Augmented Category 6 cables, where the addition of a shield (not shown) increases the amount of attenuation that would otherwise be seen if the cable was unshielded. Often this increase in attenuation could cause the cable to perform marginally with respect to industry requirements for these electrical properties.

Cable manufacturers can compensate for the attenuation increase by increasing the diameter of the conductors 20, and the thickness of the conductor insulation (e.g., the insulating jackets 22). However, this approach is often not cost effective, and increases the diameter of the cable, which may be undesirable. Further, this approach does not speed up the velocity factor “Vp.”

Lowering the dielectric constant of any of the insulating components (e.g., the center separator 18), or parts thereof, will reduce the effective dielectric constant “seen” by one or more of the pairs “P1” to “P4.” For this reason, some manufacturers foam the material(s) used to construct the center separator 18. While this may reduce the dielectric constant of the center separator 18, the extrusion equipment required to foam the material(s) is not always available at cable manufacturing facilities. Additionally, some manufacturers use materials (either in a solid form or foamed form) having lower dielectric constants, such as fluorinated ethylene propylene (“FEP”) or other similar fluoropolymers. Unfortunately, the cost of these types of materials is significantly higher than the cost of PE type materials. Further, as mentioned above, extrusion equipment required may not be available at some cable manufacturing facilities. This is a particular problem when the equipment must also foam the material.

Thus, a need exists for new wire insulation methods and structures. A need also exists for new cable structures. Methods that avoid foaming or injecting bubbles into the insulation surrounding and/or adjacent a wire pair are particularly desirable. Methods that avoid the need to coextrude wire pairs together are also desirable. The present application provides these and other advantages as will be apparent from the following detailed description and accompanying figures.

### BRIEF DESCRIPTION OF THE SEVERAL VIEWS OF THE DRAWING(S)

FIG. 1A is a lateral cross-section of a first prior art communication cable that includes eight elongated wires divided into four wire pairs.

FIG. 1B is a lateral cross-section of a second prior art communication cable that includes eight elongated wires divided into four wire pairs wherein each pair is surrounded by an insulating outer covering.

FIG. 2A is a perspective view of four prior art wire pairs in which each pair includes eccentricities, which means conductors in the wires are not centered inside their insulating jackets.

FIG. 2B is a perspective view of two prior art wire pairs in which the insulating jackets of the wires in each pair have different or varying compression moduli.

FIG. 2C is a perspective view of a prior art wire pair in which the wires have different or varying stiffness which means, instead of the wires being twisted together uniformly, a first wire in the pair is wrapped around a second wire in the pair.

FIG. 2D is a perspective view of a prior art wire pair in which air bubbles have been included in the insulating jacket of only one of the wires causing the wires to have different or varying dielectric constants.

FIG. 3A is a lateral cross-section of a cable that includes four wire pairs, wherein the wires of each wire pair are separated by a first embodiment of a central insulator.

FIG. 3B is a lateral cross-section of a subassembly including the first embodiment of the central insulator and one of the wire pairs of FIG. 3A.

FIG. 4 is a lateral cross-section of a second embodiment of a central insulator.

FIG. 5 is a lateral cross-section of a third embodiment of a central insulator.

FIG. 6 is a lateral cross-section of a fourth embodiment of a central insulator.

FIG. 7A is a perspective view of a fifth embodiment of a central insulator.

FIG. 7B is a lateral cross-section of the fifth embodiment of the central insulator.

FIG. 8 is a lateral cross-section of a sixth embodiment of a central insulator.

FIG. 9 is a lateral cross-section of a seventh embodiment of a central insulator.

FIG. 10 is a lateral cross-section of an eighth embodiment of a central insulator.

FIG. 11 is a lateral cross-section of a ninth embodiment of a central insulator.

FIG. 12 is a lateral cross-section of a tenth embodiment of a central insulator.

FIG. 13 is a lateral cross-section of an eleventh embodiment of a central insulator.

FIG. 14 is a lateral cross-section of a twelfth embodiment of a central insulator.

FIG. 15 is a lateral cross-section of a thirteen embodiment of a central insulator.

FIG. 16 is a lateral cross-section of a fourteenth embodiment of a central insulator.

FIG. 17A is a perspective view of a first embodiment of a cable configured to conduct three phase signals, wherein the cable includes two sets of three wires, and the wires of each set are separated by a fifteenth embodiment of a central insulator.

FIG. 17B is a lateral cross-section of the fifteenth embodiment of the central insulator.

FIG. 18 is a lateral cross-section of a second embodiment of a cable configured to conduct three phase signals, wherein the cable includes four sets of three wires, and the wires of each set are separated by the fifteenth embodiment of the central insulator.

FIG. 19A is a perspective view of a first embodiment of a center separator configured to resist deformation when lateral forces are applied to the center separator.

FIG. 19B is a lateral cross-section of the first embodiment of the center separator.

FIG. 20 is a lateral cross-section of a second embodiment of a center separator.

FIG. 21 is a lateral cross-section of a third embodiment of a center separator.

FIG. 22 is a lateral cross-section of a fourth embodiment of a center separator.

FIG. 23 is a lateral cross-section of a fifth embodiment of a center separator.

FIG. 24 is a lateral cross-section of a sixth embodiment of a center separator.

FIG. 25 is a perspective view of a seventh embodiment of a center separator.

FIG. 26 is a perspective view of a eighth embodiment of a center separator.

FIG. 27 is a flow diagram of a method of forming a deformation resistant center separator.

FIG. 28 is a perspective view of a cable that includes a center separator having a lower overall dielectric constant and dissipation factor than a conventional center separator.

FIG. 29 is a flow diagram of a method of forming the center separator of FIG. 28.

FIG. 30 is a perspective view of a series of rotating tool and die assemblies that may be used to form through-holes in the center separator of FIG. 28.

FIG. 31 is a perspective view of a coaxial cable that includes a central insulator positioned between a central conductor and an outer conductor.

FIG. 32 is a lateral cross-sectional view of the coaxial cable of FIG. 31 taken through a line 32-32.

### DETAILED DESCRIPTION OF THE INVENTION

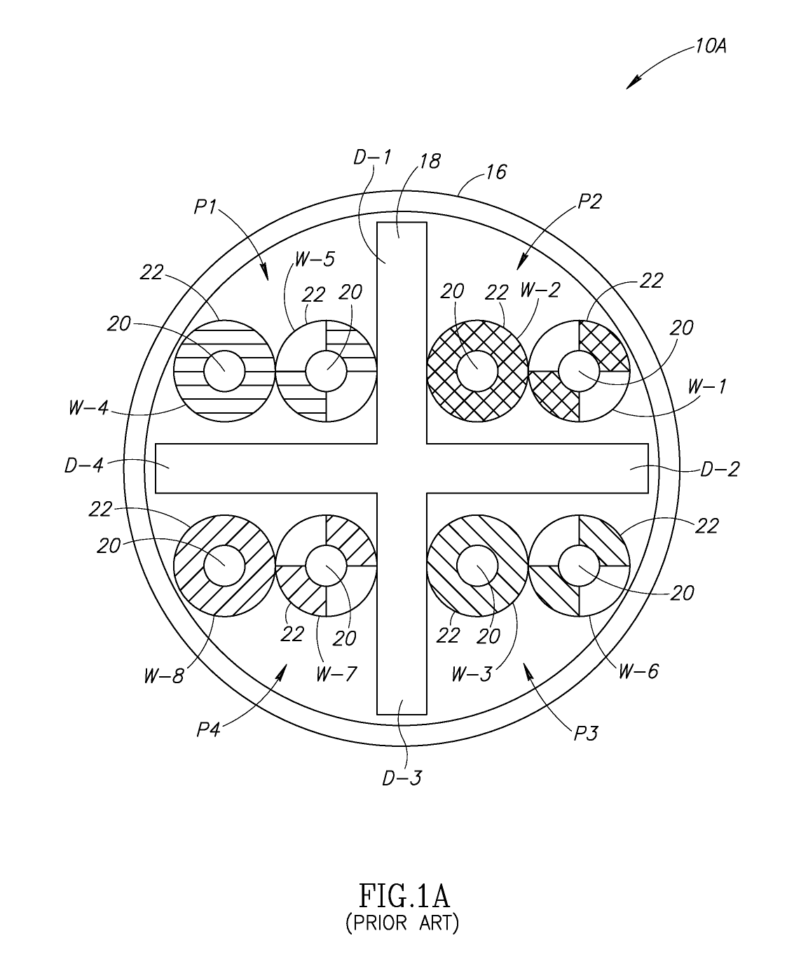

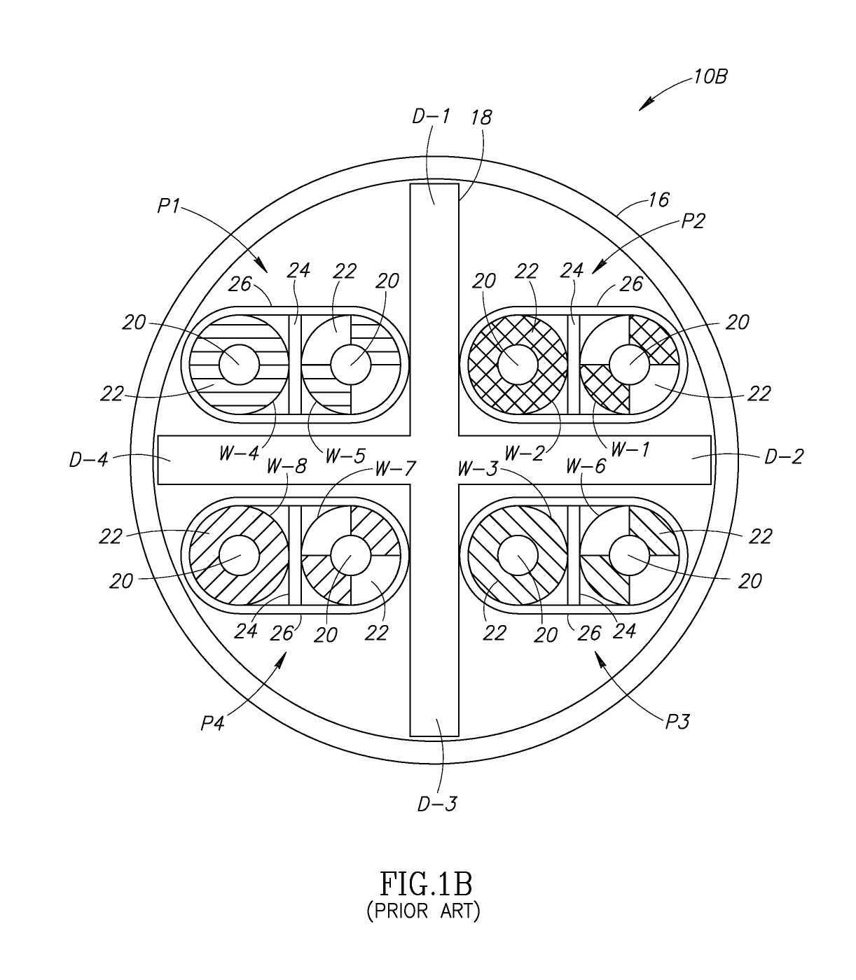

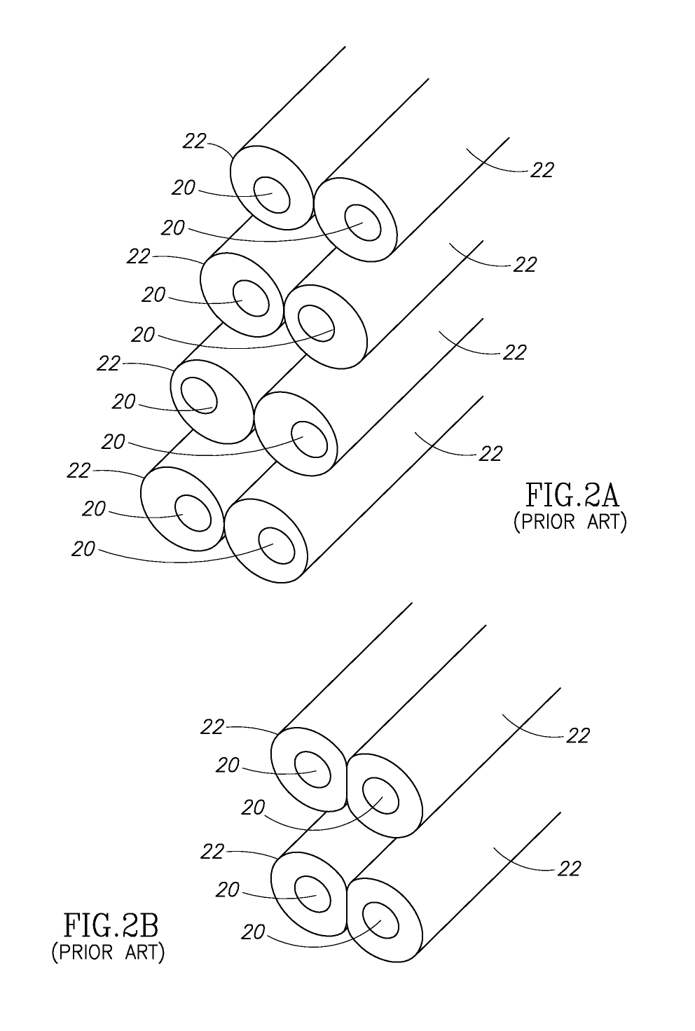

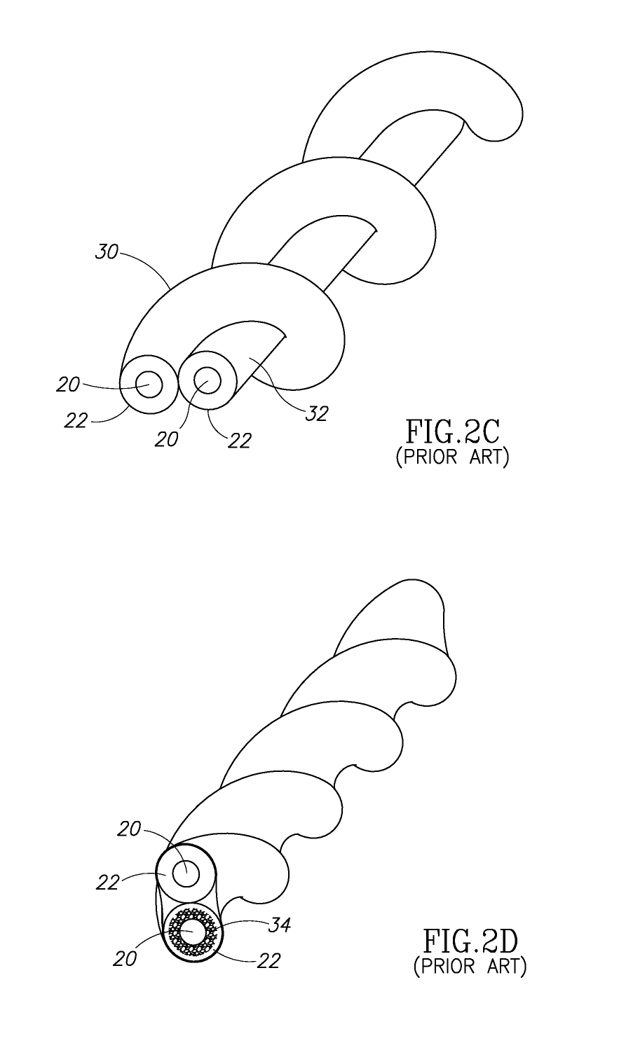

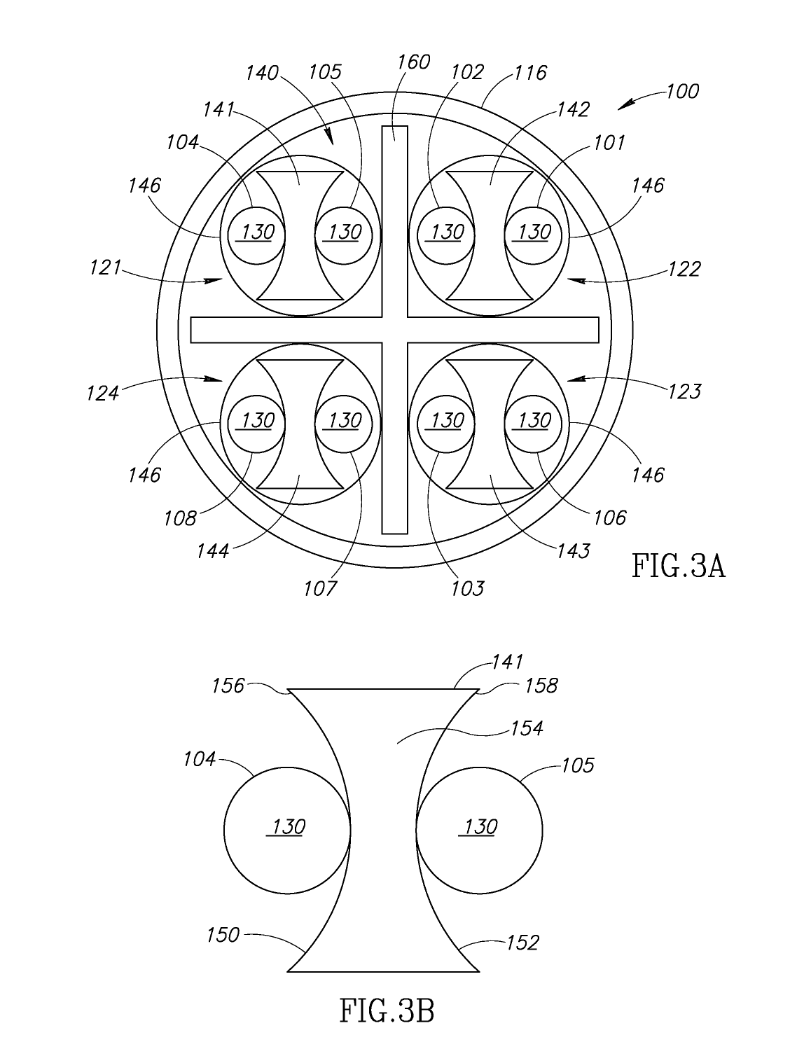

FIG. 3A depicts a lateral cross-section of a cable 100 that includes eight elongated wires 101-108 divided into four wire pairs 121-124 and surrounded by an outer cable jacket 116. The cable jacket 116 is substantially identical to the cable jacket 16 depicted in FIGS. 1A and 1B. Returning to FIG. 3A, the wires of each of the pairs 121-124 may be twisted together to form a twisted wire pair. Each of the pairs 121-124 may be used to transmit a differential signal. For ease of illustration, the pair 121 will be described as including the wires 104 and 105, the pair 122 will be described as including the wires 101 and 102, the pair 123 will be described as including the wires 103 and 106, and the pair 124 will be described as including the wires 107 and 108. The pairs 121-124 are substantially identical to one another.

The wires 101-108 are substantially identical to one another. In the embodiment illustrated, the wires 101-108 each includes an un-insulated (or bare) electrical conductor 130. In alternate embodiments, an insulating jacket (not shown) substantially similar to the insulating jacket 22 (illustrated in FIGS. 1A and 1B) may surround one or more of the wires 101-108 circumferentially. However, the insulating jacket (not shown) surrounding each of the conductors 130 may be un-foamed to avoid the non-uniformities introduced by the foaming process. The conductors 130 may be substantially identical to the conductors 20 (illustrated in FIGS. 1A and 1B). The conductor 130 may include stranded conductors, a solid conductor (e.g., a conventional copper wire), and the like.

The cable 100 includes a plurality of longitudinally elongated central insulators 140. Each of the central insulators 140 depicted in FIG. 3A is constructed in accordance with a first embodiment thereof.

A first central insulator 141 is positioned between the wires 104 and 105 of the pair 121. A second central insulator 142 is positioned between the wires 101 and 102 of the pair 122. A third central insulator 143 is positioned between the wires 103 and 106 of the pair 123. A fourth central insulator 144 is positioned between the wires 107 and 108 of the pair 124. While not illustrated in FIG. 3A, the central insulator 141 may be twisted longitudinally to arrange the wires 104 and 105 of the pair 121 into a twisted pair, the central insulator 142 may be twisted longitudinally to arrange the wires 101 and 102 of the pair 122 into a twisted pair, the central insulator 143 may be twisted longitudinally to arrange the wires 103 and 106 of the pair 123 into a twisted pair, and the central insulator 144 may be twisted longitudinally to arrange the wires 107 and 108 of the pair 124 into a twisted pair.

The central insulators 140 are constructed from an insulating material (e.g., plastic). In some embodiments, the central insulators 140 are constructed from a material having a low dielectric constant. However, the central insulators 140 may be un-foamed to avoid the non-uniformities introduced by the foaming process. The pairs 121-124 may be twisted together within the cable 100 in accordance with a cable lay. Thus, the central insulators 140 may be constructed from a flexible or semi-flexible insulating material, such as PE, cross-linked PE (“XLPE”), FRPE, FEP, other fluoropolymers, combinations thereof, and the like. XLPE is made from high-density polyethylene (“HDPE”) that has been treated (e.g., through an irradiation process or a chemical process) such that molecules in the material are cross-linked creating a mechanically superior material that may be used to construct the central insulators 140.

Optionally, each of the pairs 121-124 may be surrounded by a different insulating outer covering 146. The outer covering 146 may be substantially identical to the outer covering 26 illustrated in FIG. 1A. However, the outer covering 146 may be un-foamed to avoid the non-uniformities introduced by the foaming process.

Returning to FIG. 3A, optionally, the cable 100 may include a longitudinally elongated center separator 160 configured to separate the pairs 121-124 from one another. In the embodiment illustrated, the center separator 160 has a cross-shaped lateral cross-sectional shape. However, this is not a requirement. The center separator 160 may have a longitudinally twisted shape or be configured to be twisted so that the pairs 121-124 may be twisted together in accordance with a conventional cable lay arrangement. The center separator 160 may be constructed from an insulating material, such as PE, XLPE, FRPE, FEP, other fluoropolymers, combinations thereof, and the like. As with the central insulators 140, XLPE may be used to construct the central separator 160 because XLPE has desirable mechanical properties. Further, the center separator 160 may be un-foamed to avoid the non-uniformities introduced by the foaming process.

The structure of the first embodiment of the central insulators 140 will now be described. For ease of illustration, the structure of the first embodiment of the central insulators 140 will be described with respect to the central insulator 141, which separates the wires 104 and 105 from one another. However, as illustrated in FIG. 3A, the structure of each of the central insulators 142-144 is substantially identical to the central insulator 141.

FIG. 3B depicts a lateral cross-section of a subassembly of the central insulator 141 and the wires 104 and 105. The central insulator 141 includes a first longitudinally extending channel 150 separated from a second longitudinally extending channel 152 by an intermediate insulating portion 154. The first channel 150 has a longitudinally extending opening 156 configured to receive the wire 104 into the first channel 150, and the second channel 152 has a longitudinally extending opening 158 configured to receive the wire 105 into the second channel 152. Thus, the wires 104 and 105 are positionable within the channels 150 and 152, respectively, of the central insulator 141 after the central insulator 141 and the wires 104 and 105 have each been constructed separately. Therefore, co-extrusion need not be used to construct a subassembly of the central insulator 141 and the wires 104 and 105. Instead, each of the central insulator 141 and the wires 104 and 105 may be constructed separately and later assembled together. Optionally, the subassembly of the central insulator 141 and the wires 104 and 105 may be surrounded by the insulating outer covering 146 (see FIG. 3A).

Returning to FIG. 3A, the wires 101 and 102 are positionable within the channels 150 and 152 (see FIG. 3B), respectively, of the central insulator 142 (through the openings 156 and 158 (see FIG. 3B), respectively) after the central insulator 142 and the wires 101 and 102 have each been constructed separately. Therefore, co-extrusion need not be used to construct a subassembly of the central insulator 142 and the wires 101 and 102. Instead, each of the central insulator 142 and the wires 101 and 102 may be constructed separately and later assembled together. Optionally, the subassembly of the central insulator 142 and the wires 101 and 102 may be surrounded by the insulating outer covering 146.

The wires 103 and 106 are positionable within the channels 150 and 152 (see FIG. 3B), respectively, of the central insulator 143 (through the openings 156 and 158 (see FIG. 3B), respectively) after the central insulator 143 and the wires 103 and 106 have each been constructed separately. Therefore, co-extrusion need not be used to construct a subassembly of the central insulator 143 and the wires 103 and 106. Instead, each of the central insulator 143 and the wires 103 and 106 may be constructed separately and later assembled together. Optionally, the subassembly of the central insulator 143 and the wires 103 and 106 may be surrounded by the insulating outer covering 146.

The wires 107 and 108 are positionable within the channels 150 and 152 (see FIG. 3B), respectively, of the central insulator 144 (through the openings 156 and 158 (see FIG. 3B), respectively) after the central insulator 144 and the wires 107 and 108 have each been constructed separately. Therefore, co-extrusion need not be used to construct a subassembly of the central insulator 144 and the wires 107 and 108. Instead, each of the central insulator 144 and the wires 107 and 108 may be constructed separately and later assembled together. Optionally, the subassembly of the central insulator 144 and the wires 107 and 108 may be surrounded by the insulating outer covering 146.

Thus, the cable 100 may be constructed without using co-extrusion.

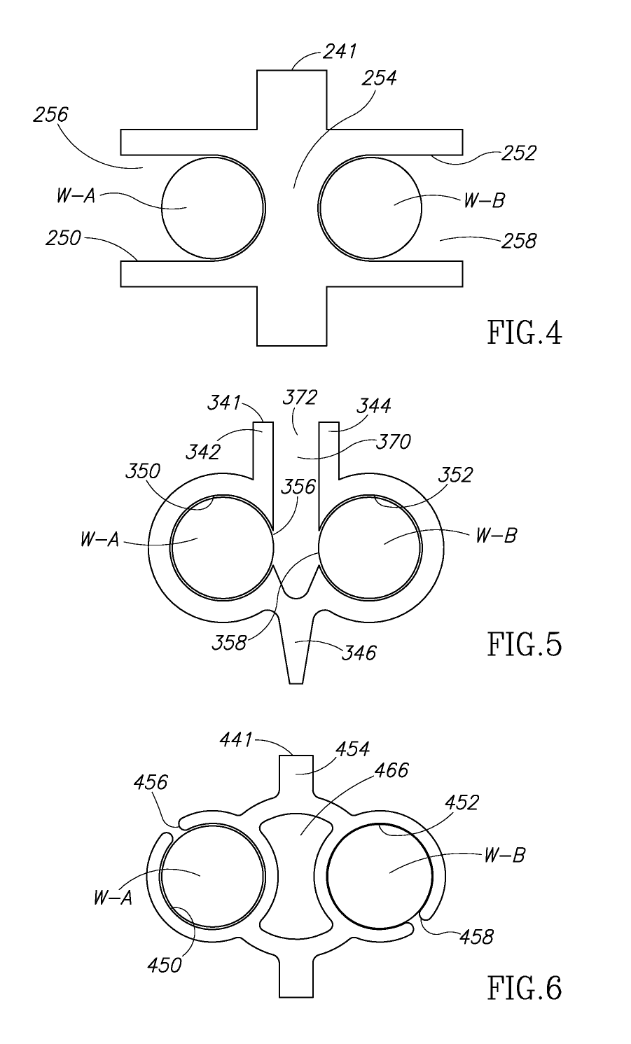

FIG. 4 depicts a lateral cross-section of a second embodiment of a longitudinally elongated central insulator 241. The central insulator 241 may replace one or more of the central insulators 140 (see FIG. 3A) in the cable 100 (see FIG. 3A). For ease of illustration, the central insulator 241 will be described as separating a first wire “W-A” from a second wire “W-B.” Returning to FIG. 3A, the first wire “W-A” may be implemented using the wire 101, 103, 104, or 107 (see FIG. 3A) of the cable 100 (see FIG. 3A), and the second wire “W-B” may be implemented using the wire 102, 105, 106, or 108 (see FIG. 3A) of the cable 100 (see FIG. 3A). Thus, the central insulator 241 may be used with respect to the wires 104 and 105 of the first pair 121, the wires 101 and 102 of the second pair 122, the wires 103 and 106 of the third pair 123, and/or the wires 107 and 108 of the fourth pair 124.

Returning to FIG. 4, the central insulator 241 may be constructed using any material suitable for constructing the central insulators 140 (see FIG. 3A). The central insulator 241 includes a first longitudinally extending channel 250 separated from a second longitudinally extending channel 252 by an intermediate insulating portion 254. The first channel 250 has a longitudinally extending opening 256 configured to receive the wire “W-A” into the first channel 250, and the second channel 252 has a longitudinally extending opening 258 configured to receive the wire “W-B” into the second channel 252. Thus, the wires “W-A” and “W-B” are positionable within the channels 250 and 252, respectively, of the central insulator 241 after the central insulator 241 and the wires “W-A” and “W-B” have each been constructed separately. Therefore, co-extrusion need not be used to construct a subassembly of the central insulator 241 and the wires “W-A” and “W-B.” Instead, each of the central insulator 241 and the wires “W-A” and “W-B” may be constructed separately and later assembled together. The central insulator 241 may be twisted longitudinally to arrange the wires “W-A” and “W-B” into a twisted pair. Optionally, the subassembly of the central insulator 241 and the wires “W-A” and “W-B” may be surrounded by an insulating outer covering (not shown) substantially similar to the insulating outer covering 146 illustrated in FIG. 3A.

FIG. 5 depicts a lateral cross-section of a third embodiment of a longitudinally elongated central insulator 341. Like reference numerals have been used to identify like structures in FIGS. 4 and 5. The central insulator 341 may replace one or more of the central insulators 140 (see FIG. 3A) in the cable 100 (see FIG. 3A). The central insulator 341 may be constructed using any material suitable for constructing the central insulators 140 (see FIG. 3A).

The central insulator 341 is generally V-shaped having a first arm 342 connected to a second arm 344 by an intermediate portion 346. A first longitudinally extending channel 350 is formed in the first arm 342. A second longitudinally extending channel 352 is formed in the second arm 344. The first channel 350 has an opening 356 configured to receive the first wire “W-A” into the first channel 350, and the second channel 352 has an opening 358 configured to receive the second wire “W-B” into the second channel 352.

As mentioned above, air has a dielectric constant of about one. The central insulator 341 has an air-filled void or air-filled gap 370 positioned between the channels 350 and 352. The air-filled gap 370 has an opening 372 opposite the intermediate portion 346 configured to receive the first wire “W-A” into the air-filled gap 370. The openings 356 and 358 of the channels 350 and 352, respectively, open into the air-filled gap 370. The first wire “W-A” may be inserted into the air-filled gap 370 through the opening 372 and then, inserted into the first channel 350 through the opening 356. The second wire “W-B” may be inserted into the air-filled gap 370 through the opening 372 and then inserted into the second channel 352 through the opening 358. The material(s) used to construct the central insulator 341 is/are sufficiently rigid to (a) retain the first wire “W-A” in the first channel 350, (b) retain the second wire “W-B” in the second channel 352, and prevent the wires “W-A” and “W-B” from contacting one another across the air-filled gap 370. In other words, the material(s) used to construct the central insulator 341 is/are sufficiently rigid to prevent the air-filled gap 370 from collapsing.

The central insulator 341 may be twisted longitudinally to arrange the wires “W-A” and “W-B” into a twisted pair. Optionally, a subassembly of the central insulator 341 and the wires “W-A” and “W-B” may be surrounded by an insulating outer covering (not shown) substantially similar to the insulating outer covering 146 illustrated in FIG. 3A.

FIG. 6 depicts a lateral cross-section of a fourth embodiment of a longitudinally elongated central insulator 441. Like reference numerals have been used to identify like structures in FIGS. 4 and 6. The central insulator 441 may replace one or more of the central insulators 140 (see FIG. 3A) in the cable 100 (see FIG. 3A). The central insulator 441 may be constructed using any material suitable for constructing the central insulators 140 (see FIG. 3A).

The central insulator 441 includes a first longitudinally extending channel 450 separated from a second longitudinally extending channel 452 by an intermediate insulating portion 454. An air-filled void or air-filled gap 466 is formed in the intermediate insulating portion 454 and positioned between the first and second channels 450 and 452. The first channel 450 has a longitudinally extending opening 456 configured to receive the wire “W-A” into the first channel 450, and the second channel 452 has a longitudinally extending opening 458 configured to receive the wire “W-B” into the second channel 452. Thus, the wires “W-A” and “W-B” are positionable within the channels 450 and 452, respectively, of the central insulator 441 after the central insulator 441 and the wires “W-A” and “W-B” have each been constructed separately. Therefore, co-extrusion need not be used to construct a subassembly of the central insulator 441 and the wires “W-A” and “W-B.” Instead, each of the central insulator 441 and the wires “W-A” and “W-B” may be constructed separately and later assembled together. The central insulator 441 may be twisted longitudinally to arrange the wires “W-A” and “W-B” into a twisted pair. Optionally, the subassembly of the central insulator 441 and the wires “W-A” and “W-B” may be surrounded by an insulating outer covering (not shown) substantially similar to the insulating outer covering 146 illustrated in FIG. 3A.

### Truss-Type Central Insulators

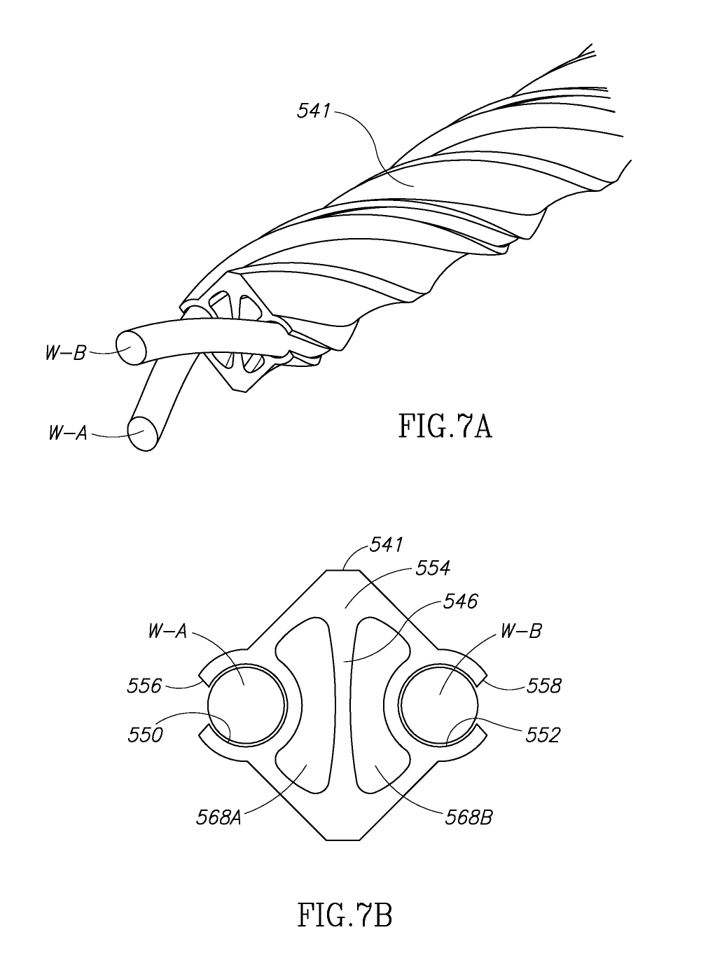

Additional embodiments of longitudinally elongated central insulators are depicted in FIGS. 7A-16. These embodiments may be characterized as being truss-type central insulators because each of these embodiments includes one or more longitudinally extending air-filled gaps (or air-filled voids) and one or more longitudinally extending lateral supports positioned between the wires “W-A” and “W-B.” The combination of the air-filled gaps and supports makes the truss-type central insulators more deformation (e.g., crush) resistant than conventional foamed center separators that include air bubbles. Thus, these embodiments avoid the non-uniformities introduced into conventional center separators by air bubbles (e.g., caused by clustering of the air bubbles).

The truss-type central insulators depicted in FIGS. 7A-16 may be used to construct Transverse ElectroMagnetic (“TEM”) mode transmission lines. Such lines may be used as low loss transmission lines for high-speed data and/or radio frequency signals. Such lines avoid manufacturing steps (e.g., foaming) that induce imbalance in a transmission line. Therefore, such lines may be produced at lower costs than conventional TEM mode transmission lines.

FIGS. 7A and 7B depict a fifth embodiment of a longitudinally elongated central insulator 541. FIG. 7A is a perspective view of the central insulator 541 and the wires “W-A” and “W-B.” FIG. 7B is a lateral cross-section of the central insulator 541 and the wires “W-A” and “W-B.” Like reference numerals have been used to identify like structures in FIGS. 4, 7A, and 7B. The central insulator 541 may replace one or more of the central insulators 140 (see FIG. 3A) in the cable 100 (see FIG. 3A). The central insulator 541 may be constructed using any material suitable for constructing the central insulators 140 (see FIG. 3A). The central insulator 541 may be twisted longitudinally (as illustrated in FIG. 7A) to arrange the wires “W-A” and “W-B” into a twisted pair. Optionally, a subassembly of the central insulator 551 and the wires “W-A” and “W-B” may be surrounded by an insulating outer covering (not shown) substantially similar to the insulating outer covering 146 illustrated in FIG. 3A.

Turning to FIG. 7B, the central insulator 541 includes a first longitudinally extending channel 550 separated from a second longitudinally extending channel 552 by an intermediate insulating portion 554. A longitudinally extending septum or intermediate lateral support 546 is formed in the intermediate insulating portion 554 and positioned between the first and second channels 550 and 552. The intermediate lateral support 546 helps resist deformation (e.g., crushing). A longitudinally extending first air-filled gap 568A is positioned between the first channel 550 and the intermediate lateral support 546. A longitudinally extending second air-filled gap 568B is positioned between the second channel 552 and the intermediate lateral support 546. The air-filled gaps 568A and 568B help reduce the dielectric constant of the central insulator 541.

The first channel 550 has a longitudinally extending opening 556 configured to receive the wire “W-A” into the first channel 550, and the second channel 552 has a longitudinally extending opening 558 configured to receive the wire “W-B” into the second channel 552. Thus, the wires “W-A” and “W-B” are positionable within the channels 550 and 552, respectively, of the central insulator 551 after the central insulator 551 and the wires “W-A” and “W-B” have each been constructed separately. Therefore, co-extrusion need not be used to construct a subassembly of the central insulator 551 and the wires “W-A” and “W-B.” Instead, each of the central insulator 551 and the wires “W-A” and “W-B” may be constructed separately and later assembled together.

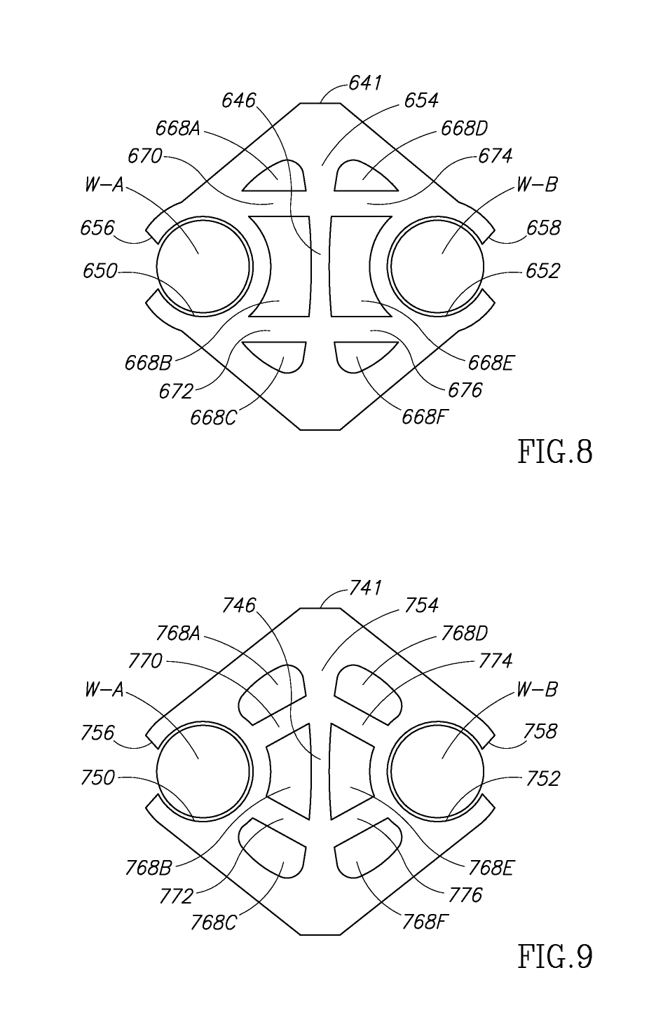

FIG. 8 depicts a lateral cross-section of a sixth embodiment of a longitudinally elongated central insulator 641. Like reference numerals have been used to identify like structures in FIGS. 4 and 8. The central insulator 641 may replace one or more of the central insulators 140 (see FIG. 3A) in the cable 100 (see FIG. 3A). The central insulator 641 may be constructed using any material suitable for constructing the central insulators 140 (see FIG. 3A). The central insulator 641 may be twisted longitudinally to arrange the wires “W-A” and “W-B” into a twisted pair. Optionally, a subassembly of the central insulator 651 and the wires “W-A” and “W-B” may be surrounded by an insulating outer covering (not shown) substantially similar to the insulating outer covering 146 illustrated in FIG. 3A.

The central insulator 641 includes a first longitudinally extending channel 650 separated from a second longitudinally extending channel 652 by an intermediate insulating portion 654. A longitudinally extending septum or intermediate lateral support 646 is formed in the intermediate insulating portion 654 and positioned between the first and second channels 650 and 652. The intermediate insulating portion 654 includes longitudinally extending air-filled gaps 668A-668E. The air-filled gaps 668A-668C are positioned alongside the intermediate lateral support 646 on the same side as the first channel 650. The air-filled gaps 668D-668F are positioned alongside the intermediate lateral support 646 on the same side as the second channel 652. A longitudinally extending lateral support 670 extends between the air-filled gaps 668A and 668B. A longitudinally extending lateral support 672 extends between the air-filled gaps 668B and 668C. A longitudinally extending lateral support 674 extends between the air-filled gaps 668D and 668E. A longitudinally extending lateral support 676 extends between the air-filled gaps 668E and 668F. In the embodiment illustrated, the lateral supports 674-676 are substantially orthogonal to the intermediate lateral support 646. The intermediate lateral support 646 and the lateral supports 674-676 help resist deformation (e.g., crushing). The air-filled gaps 668A-668E help reduce the dielectric constant of the central insulator 641.

The first channel 650 has a longitudinally extending opening 656 configured to receive the wire “W-A” into the first channel 650, and the second channel 652 has a longitudinally extending opening 658 configured to receive the wire “W-B” into the second channel 652. Thus, the wires “W-A” and “W-B” are positionable within the channels 650 and 652, respectively, of the central insulator 651 after the central insulator 651 and the wires “W-A” and “W-B” have each been constructed separately. Therefore, co-extrusion need not be used to construct a subassembly of the central insulator 651 and the wires “W-A” and “W-B.” Instead, each of the central insulator 651 and the wires “W-A” and “W-B” may be constructed separately and later assembled together.

FIG. 9 depicts a lateral cross-section of a seventh embodiment of a longitudinally elongated central insulator 741. Like reference numerals have been used to identify like structures in FIGS. 4 and 9. The central insulator 741 may replace one or more of the central insulators 140 (see FIG. 3A) in the cable 100 (see FIG. 3A). The central insulator 741 may be constructed using any material suitable for constructing the central insulators 140 (see FIG. 3A). The central insulator 741 may be twisted longitudinally to arrange the wires “W-A” and “W-B” into a twisted pair. Optionally, a subassembly of the central insulator 751 and the wires “W-A” and “W-B” may be surrounded by an insulating outer covering (not shown) substantially similar to the insulating outer covering 146 illustrated in FIG. 3A.

The central insulator 741 includes a first longitudinally extending channel 750 separated from a second longitudinally extending channel 752 by an intermediate insulating portion 754. A longitudinally extending septum or intermediate lateral support 746 is formed in the intermediate insulating portion 754 and positioned between the first and second channels 750 and 752. The intermediate insulating portion 754 includes longitudinally extending air-filled gaps 768A-768E. The air-filled gaps 768A-768C are positioned alongside the intermediate lateral support 746 on the same side as the first channel 750. The air-filled gaps 768D-768F are positioned alongside the intermediate lateral support 746 on the same side as the second channel 752. A longitudinally extending lateral support 770 extends between the air-filled gaps 768A and 768B. A longitudinally extending lateral support 772 extends between the air-filled gaps 768B and 768C. A longitudinally extending lateral support 774 extends between the air-filled gaps 768D and 768E. A longitudinally extending lateral support 776 extends between the air-filled gaps 768E and 768F. In the embodiment illustrated, the lateral supports 774-776 are angled with respect to (but are not orthogonal to) the intermediate lateral support 746. The intermediate lateral support 746 and the lateral supports 774-776 help resist deformation (e.g., crushing). The air-filled gaps 768A-768E help reduce the dielectric constant of the central insulator 741.

The first channel 750 has a longitudinally extending opening 756 configured to receive the wire “W-A” into the first channel 750, and the second channel 752 has a longitudinally extending opening 758 configured to receive the wire “W-B” into the second channel 752. Thus, the wires “W-A” and “W-B” are positionable within the channels 750 and 752, respectively, of the central insulator 751 after the central insulator 751 and the wires “W-A” and “W-B” have each been constructed separately. Therefore, co-extrusion need not be used to construct a subassembly of the central insulator 751 and the wires “W-A” and “W-B.” Instead, each of the central insulator 751 and the wires “W-A” and “W-B” may be constructed separately and later assembled together.

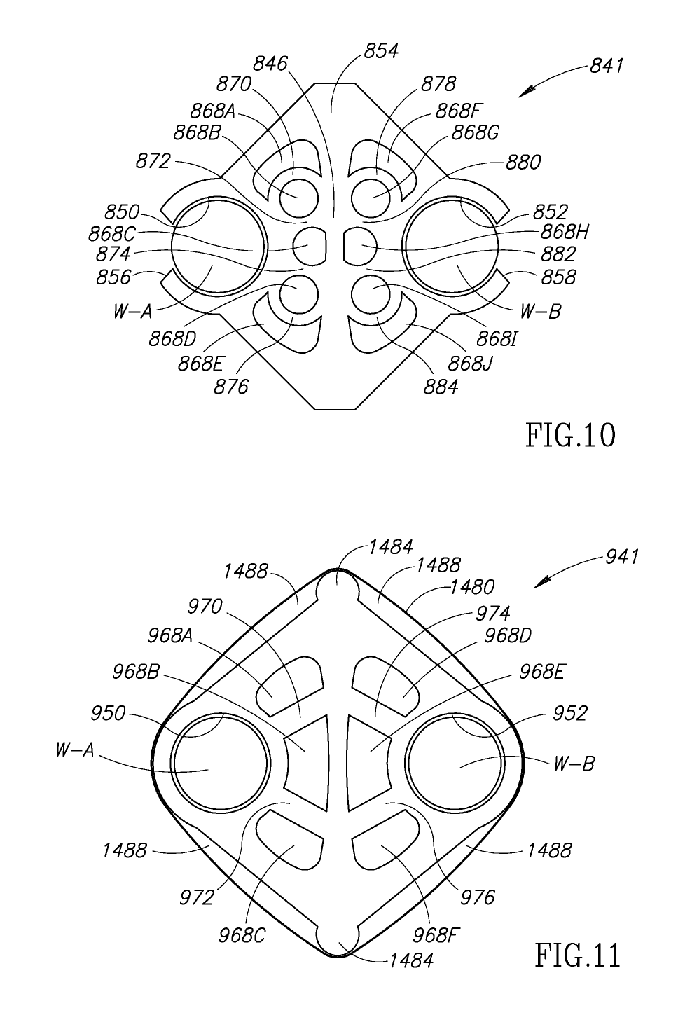

FIG. 10 depicts a lateral cross-section of an eighth embodiment of a longitudinally elongated central insulator 841. Like reference numerals have been used to identify like structures in FIGS. 4 and 10. The central insulator 841 may replace one or more of the central insulators 140 (see FIG. 3A) in the cable 100 (see FIG. 3A). The central insulator 841 may be constructed using any material suitable for constructing the central insulators 140 (see FIG. 3A). The central insulator 841 may be twisted longitudinally to arrange the wires “W-A” and “W-B” into a twisted pair. Optionally, a subassembly of the central insulator 841 and the wires “W-A” and “W-B” may be surrounded by an insulating outer covering (not shown) substantially similar to the insulating outer covering 146 illustrated in FIG. 3A.

The central insulator 841 includes a first longitudinally extending channel 850 separated from a second longitudinally extending channel 852 by an intermediate insulating portion 854. The intermediate insulating portion 854 includes an intermediate lateral support 846 substantially similar to the intermediate lateral support 746 (see FIG. 9) of the central insulator 741 (see FIG. 9). The central insulator 841 also includes air-filled gaps 868A-868J and lateral supports 870-884. The air-filled gaps 868A-868J help reduce the dielectric constant of the central insulator 841. The intermediate lateral support 846 and the lateral supports 870-884 help resist deformation (e.g., crushing).

The first channel 850 has a longitudinally extending opening 856 configured to receive the wire “W-A” into the first channel 850, and the second channel 852 has a longitudinally extending opening 858 configured to receive the wire “W-B” into the second channel 852. Thus, the wires “W-A” and “W-B” are positionable within the channels 850 and 852, respectively, of the central insulator 841 after the central insulator 841 and the wires “W-A” and “W-B” have each been constructed separately. Therefore, co-extrusion need not be used to construct a subassembly of the central insulator 841 and the wires “W-A” and “W-B.” Instead, each of the central insulator 841 and the wires “W-A” and “W-B” may be constructed separately and later assembled together.

FIG. 11 depicts a lateral cross-section of a ninth embodiment of a longitudinally elongated central insulator 941. Like reference numerals have been used to identify like structures in FIGS. 4 and 11. The central insulator 941 may replace one or more of the central insulators 140 (see FIG. 3A) in the cable 100 (see FIG. 3A). The central insulator 941 may be constructed using any material suitable for constructing the central insulators 140 (see FIG. 3A). The central insulator 941 may be twisted longitudinally to arrange the wires “W-A” and “W-B” into a twisted pair. Optionally, a subassembly of the central insulator 941 and the wires “W-A” and “W-B” may be surrounded by an insulating outer covering (not shown) substantially similar to the insulating outer covering 146 illustrated in FIG. 3A.

The central insulator 941 includes a first longitudinally extending channel 950 separated from a second longitudinally extending channel 952 by an intermediate insulating portion 954. The intermediate insulating portion 954 includes an intermediate lateral support 946 substantially similar to the intermediate lateral support 746 (see FIG. 9) of the central insulator 741 (see FIG. 9). The central insulator 941 also includes air-filled gaps 968A-968F substantially similar to the air-filled gaps 768A-768F (see FIG. 9) of the central insulator 741 (see FIG. 9), and lateral supports 970-976 substantially similar to the lateral supports 770-776 (see FIG. 9) of the central insulator 741 (see FIG. 9). The air-filled gaps 968A-968F help reduce the dielectric constant of the central insulator 941. The intermediate lateral support 946 and the lateral supports 970-984 help resist deformation (e.g., crushing).

The first channel 950 is configured to receive and house the wire “W-A,” and the second channel 952 is configured to receive and house the wire “W-B.” However, the channels 952 and 952 lack longitudinally extending openings. Thus, the wires “W-A” and “W-B” must be coextruded with the central insulator 951.

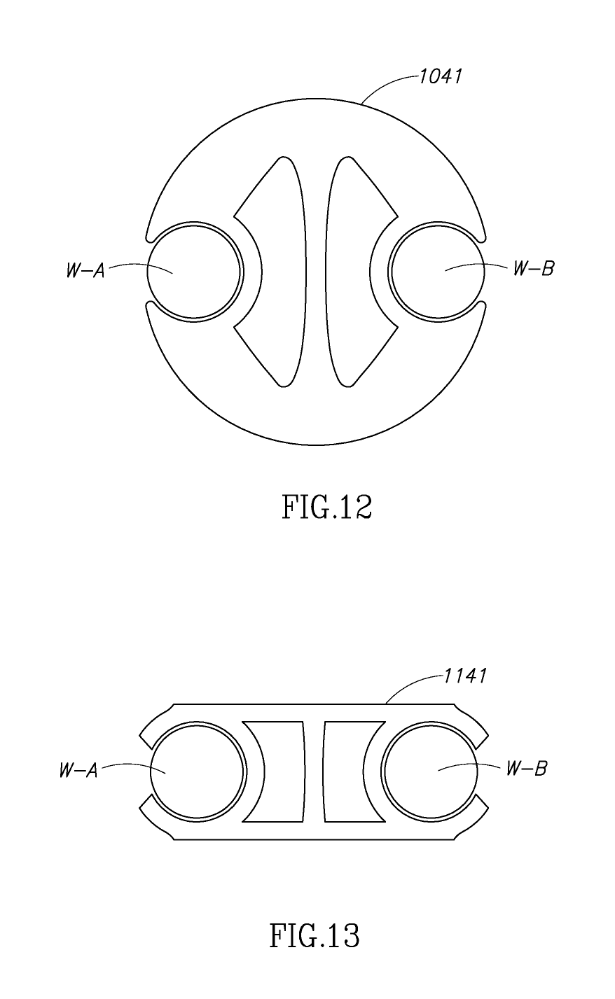

FIG. 12 depicts a lateral cross-section of a tenth embodiment of a longitudinally elongated central insulator 1041. Like reference numerals have been used to identify like structures in FIGS. 4 and 12. The central insulator 1041 may replace one or more of the central insulators 140 (see FIG. 3A) in the cable 100 (see FIG. 3A). The central insulator 1041 may be constructed using any material suitable for constructing the central insulators 140 (see FIG. 3A). The central insulator 1041 may be twisted longitudinally to arrange the wires “W-A” and “W-B” into a twisted pair. Optionally, a subassembly of the central insulator 1051 and the wires “W-A” and “W-B” may be surrounded by an insulating outer covering (not shown) substantially similar to the insulating outer covering 146 illustrated in FIG. 3A. The central insulator 1041 differs substantially from the central insulator 541 (see FIG. 7B) only with respect to its outer cross-sectional shape.

FIG. 13 depicts a lateral cross-section of an eleventh embodiment of a longitudinally elongated central insulator 1141. Like reference numerals have been used to identify like structures in FIGS. 4 and 13. The central insulator 1141 may replace one or more of the central insulators 140 (see FIG. 3A) in the cable 100 (see FIG. 3A). The central insulator 1141 may be constructed using any material suitable for constructing the central insulators 140 (see FIG. 3A). The central insulator 1141 may be twisted longitudinally to arrange the wires “W-A” and “W-B” into a twisted pair. Optionally, a subassembly of the central insulator 1141 and the wires “W-A” and “W-B” may be surrounded by an insulating outer covering (not shown) substantially similar to the insulating outer covering 146 illustrated in FIG. 3A. The central insulator 1141 differs substantially from the central insulator 541 (see FIG. 7B) only with respect to its outer cross-sectional shape.

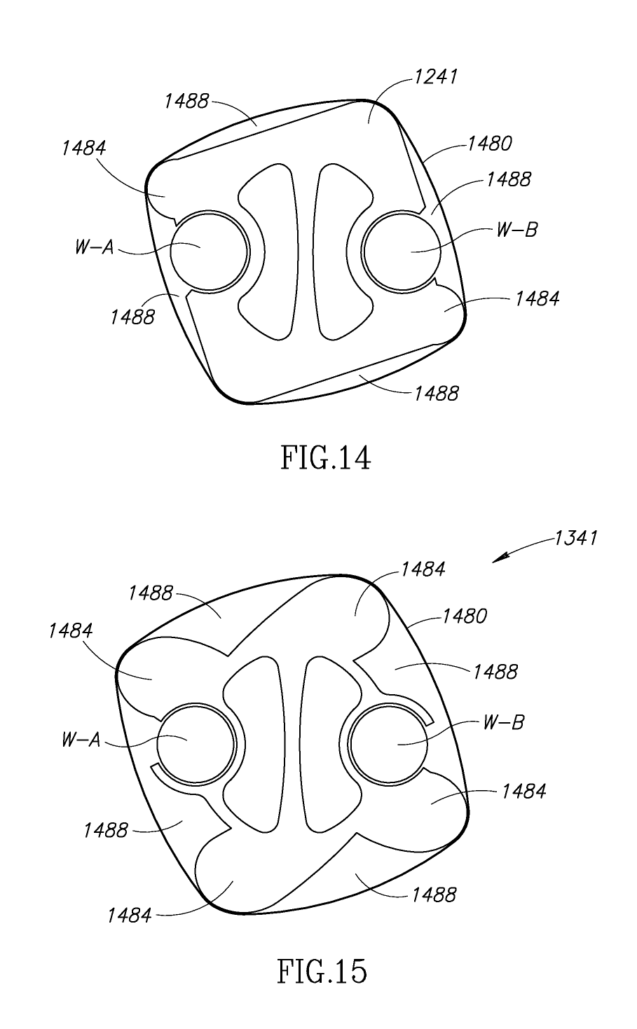

FIG. 14 depicts a lateral cross-section of a twelfth embodiment of a longitudinally elongated central insulator 1241. Like reference numerals have been used to identify like structures in FIGS. 4 and 14. The central insulator 1241 may replace one or more of the central insulators 140 (see FIG. 3A) in the cable 100 (see FIG. 3A). The central insulator 1241 may be constructed using any material suitable for constructing the central insulators 140 (see FIG. 3A). The central insulator 1241 may be twisted longitudinally to arrange the wires “W-A” and “W-B” into a twisted pair. Optionally, a subassembly of the central insulator 1241 and the wires “W-A” and “W-B” may be surrounded by an insulating outer covering (not shown) substantially similar to the insulating outer covering 146 illustrated in FIG. 3A. The central insulator 1241 differs substantially from the central insulator 541 (see FIG. 7B) only with respect to its outer cross-sectional shape.

FIG. 15 depicts a lateral cross-section of a thirteen embodiment of a longitudinally elongated central insulator 1341. Like reference numerals have been used to identify like structures in FIGS. 4 and 15. The central insulator 1341 may replace one or more of the central insulators 140 (see FIG. 3A) in the cable 100 (see FIG. 3A). The central insulator 1341 may be constructed using any material suitable for constructing the central insulators 140 (see FIG. 3A). The central insulator 1341 may be twisted longitudinally to arrange the wires “W-A” and “W-B” into a twisted pair. Optionally, a subassembly of the central insulator 1341 and the wires “W-A” and “W-B” may be surrounded by an insulating outer covering (not shown) substantially similar to the insulating outer covering 146 illustrated in FIG. 3A. The central insulator 1341 differs substantially from the central insulator 541 (see FIG. 7B) only with respect to its outer cross-sectional shape.

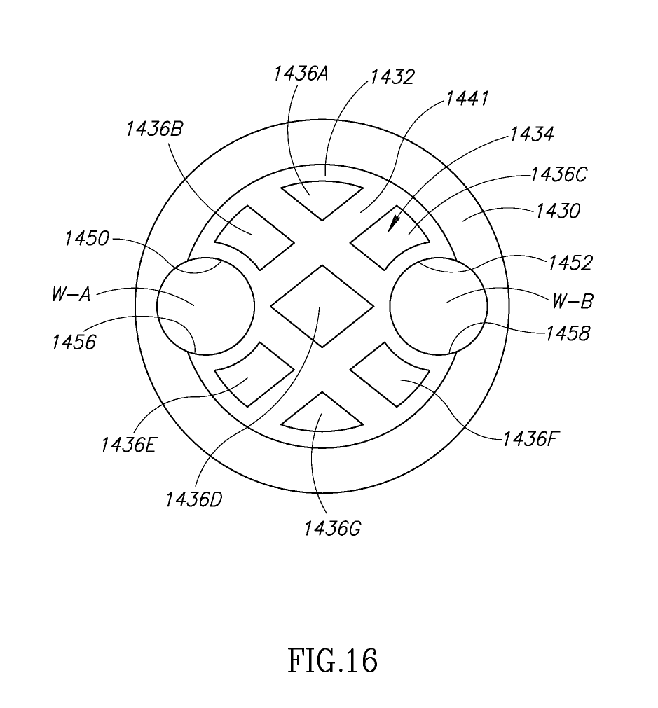

FIG. 16 depicts a lateral cross-section of a fourteenth embodiment of a longitudinally elongated central insulator 1441. Like reference numerals have been used to identify like structures in FIGS. 4 and 16. The central insulator 1441 may replace one or more of the central insulators 140 (see FIG. 3A) in the cable 100 (see FIG. 3A). The central insulator 1441 may be constructed using any material suitable for constructing the central insulators 140 (see FIG. 3A). The central insulator 1441 may be twisted longitudinally to arrange the wires “W-A” and “W-B” into a twisted pair. Optionally, a subassembly of the central insulator 1441 and the wires “W-A” and “W-B” may be surrounded by an insulating outer covering 1430 substantially similar to the insulating outer covering 146 illustrated in FIG. 3A.

Returning to FIG. 16, the central insulator 1441 includes an outer wall 1432. A first longitudinally extending channel 1450 and a second longitudinally extending channel 1452 are formed in the outer wall 1432. In the embodiment illustrated, the outer wall 1432 has a substantially circular cross-sectional shape and the channels 1450 and 1452 are positioned opposite each other along the outer wall 1432. Inside the outer wall 1432, the central insulator 1441 has a longitudinally extending support lattice 1434 that defines longitudinally extending interstitial spaces 1436A-1436G filled with air. The interstitial spaces 1436A-1436G help reduce the dielectric constant of the central insulator 1441. The support lattice 1434 helps resist deformation (e.g., crushing).

The first channel 1450 has a longitudinally extending opening 1456 positioned along the outer wall 1432 configured to receive the wire “W-A” into the first channel 1450, and the second channel 1452 has a longitudinally extending opening 1458 along the outer wall 1432 configured to receive the wire “W-B” into the second channel 1452. Thus, the wires “W-A” and “W-B” are positionable within the channels 1450 and 1452, respectively, of the central insulator 1441 after the central insulator 1441 and the wires “W-A” and “W-B” have each been constructed separately. Therefore, co-extrusion need not be used to construct a subassembly of the central insulator 1441 and the wires “W-A” and “W-B.” Instead, each of the central insulator 1441 and the wires “W-A” and “W-B” may be constructed separately and later assembled together.

Turning to FIGS. 11, 14, and 15, the central insulators 941, 1241, and 1341, respectively, may each be surrounded by an optional conductive shield 1480. By way of a non-limiting example, the conductive shield 1480 may be constructed from a conductive foil. While described with respect to the central insulators 941, 1241, and 1341, the conductive shield 1480 may surround any of the embodiments of the truss-type central insulators described above. The conductive shield 1480 encloses at least a portion of the wires “W-A” and “W-B.” The central insulators 941, 1241, and 1341 each include outwardly extending protrusions 1484 that may define robust (e.g., collapse resistant) air filled portions 1488 between each of the central insulators 941, 1241, and 1341 and the surrounding conductive shield 1480. The air filled portions 1488 may be configured (e.g., have a sufficient size) to reduce electrical coupling between the conductive shield 1480 and the wires “W-A” and “W-B” that may otherwise interfere with the integrity of transmitted signals. The protrusions 1484 may be rounded or lobe-shaped to help reduce or prevent the central insulators 941, 1241, and 1341 from tearing the conductive shield 1480.

### Three Phase Cables

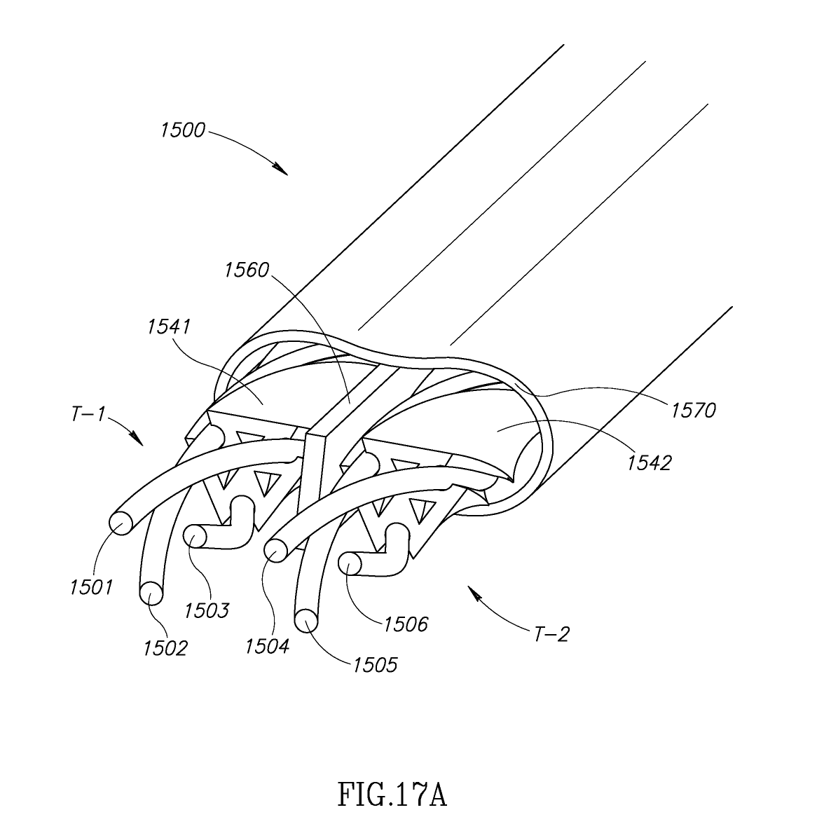

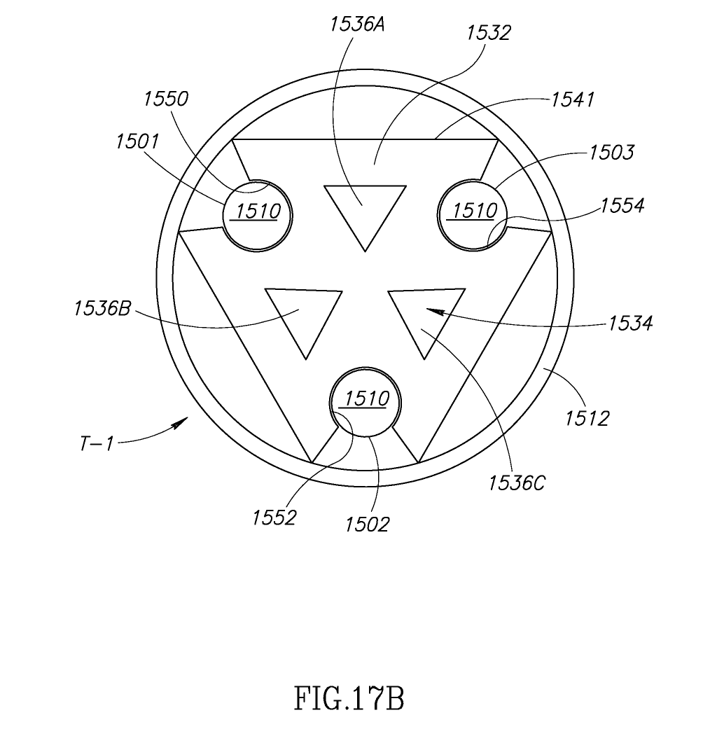

As mentioned above, the pair of wires “W-A” and “W-B” may be used to conduct a single differential signal. However, if three wires are used to conduct a three-phase signal, the three wires may be used to conduct two separate signals. Thus, six wires may be used to replace eight wires in a conventional communication cable. FIG. 17A is a perspective view of such a cable 1500. The cable 1500 includes wires 1501-1506 arranged in a first triplet or wire trio “T-1” and a second triplet or wire trio “T-2.” Each of the wire trios “T-1” and “T-2” provides two communications channels. Thus, the cable 1500 provides four communications channels.

The wires 1501-1506 are substantially identical to one another. In the embodiment illustrated, the wires 1501-1506 each includes an un-insulated (or bare) electrical conductor 1510 (see FIG. 17B). However, in alternate embodiments, an insulating jacket (not shown) substantially similar to the insulating jacket 22 (illustrated in FIGS. 1A and 1B) may surround one or more of the wires 1501-1506 circumferentially. However, the insulating jacket (not shown) surrounding each of the conductors 1510 may be un-foamed to avoid the non-uniformities introduced by the foaming process. The conductors 1510 (see FIG. 17B) may be substantially identical to the conductors 20 (illustrated in FIGS. 1A and 1B). The conductors 1510 (see FIG. 17B) may include stranded conductors, a solid conductor (e.g., a conventional copper wire), and the like. In embodiments in which the conductors 1510 are each implemented as a copper conductor, the cable 1500 may include three quarters the amount of copper used to construct a conventional eight wire cable (see FIGS. 1A and 1B).

The cable 1500 includes a plurality of longitudinally elongated central insulators 1541 and 1542. The central insulators 1541 and 1542 depicted in FIG. 17A are substantially identical to one another. The central insulators 1541 and 1542 may be constructed using any material suitable for constructing the central insulators 140 (see FIG. 3A). The central insulators 1541 and 1542 may be un-foamed to avoid the non-uniformities introduced by the foaming process.

The first central insulator 1541 is positioned between the wires 1501-1503 of the first trio “T-1.” The second central insulator 1542 is positioned between the wires 1504-1506 of the second trio “T-2.” The central insulator 1541 may be twisted longitudinally to arrange the wires 1501-1503 of the first trio “T-1” in a first twisted wire trio, and the central insulator 1542 may be twisted longitudinally to arrange the wires 1504-1506 of the second trio “T-2” in a second twisted wire trio. Optionally, a subassembly of the central insulator 1541 and the wires 1501-1503 may be surrounded by an insulating outer covering 1512 (see FIG. 17B) substantially similar to the insulating outer covering 146 illustrated in FIG. 3A. Similarly, returning to FIG. 17A, a subassembly of the central insulator 1542 and the wires 1504-1506 may be surrounded by an insulating outer covering (not shown) substantially similar to the insulating outer covering 1512 illustrated in FIG. 17B.

Returning to FIG. 17A, the structure of the central insulators 1541 and 1542 will now be described. For ease of illustration, the structure of the central insulators 1541 and 1542 will be described with respect to the central insulator 1541, which separates the wires 1501-1503 from one another. However, as illustrated in FIG. 17A, the structure of the central insulator 1542 is substantially identical to the central insulator 1541.

FIG. 17B depicts a lateral cross-section of the central insulator 1541. The central insulator 1541 includes an outer wall 1532. A first longitudinally extending channel 1550, a second longitudinally extending channel 1552, and a third longitudinally extending channel 1554 are formed in the outer wall 1532. In the embodiment illustrated, the outer wall 1532 has a substantially triangular cross-sectional shape and the channels 1450-1454 are positioned at the corners of the triangularly shaped outer wall 1532. Inside the outer wall 1532, the central insulator 1541 has a longitudinally extending support lattice 1534 that defines longitudinally extending interstitial spaces 1536A-1536C filled with air. The interstitial spaces 1536A-1536C help reduce the dielectric constant of the central insulator 1541. The support lattice 1534 helps resist deformation (e.g., crushing).

Optionally, returning to FIG. 17A, the cable 1500 may include a longitudinally elongated center separator 1560 configured to separate the two wire trios “T-1” and “T-2” from one another. In the embodiment illustrated, the center separator 1560 has a rectangular-shaped cross-sectional shape. However, this is not a requirement. The center separator 1560 may have a longitudinally twisted shape or be configured to be twisted so that the trios “T-1” and “T-2” may be twisted together in accordance with a conventional cable lay arrangement. The center separator 1560 may be constructed from any material suitable for constructing the center separator 160 (see FIG. 3A). The center separator 1560 may be un-foamed to avoid the non-uniformities introduced by the foaming process.

The cable 1500 includes an outer cable jacket 1570 substantial similar to the outer cable jacket 116 (see FIG. 3A). The cable jacket 1570 may be un-foamed to avoid the non-uniformities introduced by the foaming process.

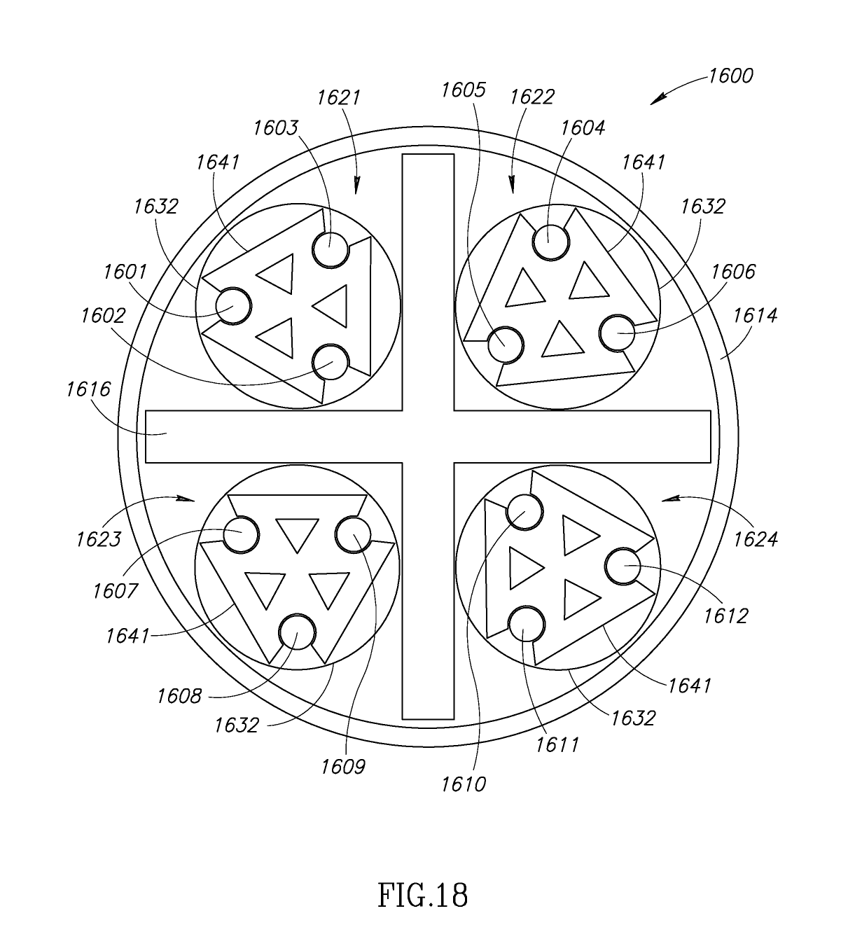

FIG. 18 depicts a lateral cross-section of a second embodiment of a cable 1600 configured to conduct three phase signals. The cable 1600 includes twelve wires 1601-1612 organized into four wire trios 1621-1624. Each of the wire trios 1621-1624 forms a subassembly with a different central insulator 1641 substantially similar to the central insulator 1541 (see FIGS. 17A and 17B). Optionally, each of the subassemblies may be surrounded by an insulating outer covering 1632 (see FIG. 17B) substantially similar to the insulating outer covering 146 illustrated in FIG. 3A.

The cable 1600 is configured to conduct eight signals. Thus, the cable 1600 has twice the signal carrying capacity as the cable 1500 (see FIG. 17A). Each of the wire trios 1621-1624 provides two communications channels. Thus, the cable 1600 provides eight communications channels. The cable 1600 includes an outer cable jacket 1614 substantial similar to the outer cable jacket 116 (see FIG. 3A). Optionally, the cable 1600 may include a longitudinally elongated center separator 1616 configured to separate the four wire trios 1621-1624 from one another. In the embodiment illustrated, the center separator 1616 has a cross-shaped cross-sectional shape. However, this is not a requirement. The center separator 1616 may have a longitudinally twisted shape or be configured to be twisted so that the wire trios 1621-1624 may be twisted together in accordance with a conventional cable lay arrangement. The center separator 1616 may be constructed from any material suitable for constructing the center separator 160 (see FIG. 3A). The center separator 1616 may be un-foamed to avoid the non-uniformities introduced by the foaming process.

### Deformation Resistant Center Separators

Conventional center separators, such as the center separator 18 depicted in FIGS. 1A and 1B may be crushed and/or deformed by laterally applied forces. Such deformation may convert the lateral cross-sectional shape of the center separator 18 (defined at least in part by a plurality of outwardly extending dividers or vanes) from generally “+” shaped to generally “X” shaped, which repositions the wires in the cable with respect to one another and can cause undesirable crosstalk between the wires in the cable (referred to as “local crosstalk”), and wires in other nearby cables (referred to as “alien crosstalk”). Such deformation may be described as transversely displacing the dividers of the center separators.

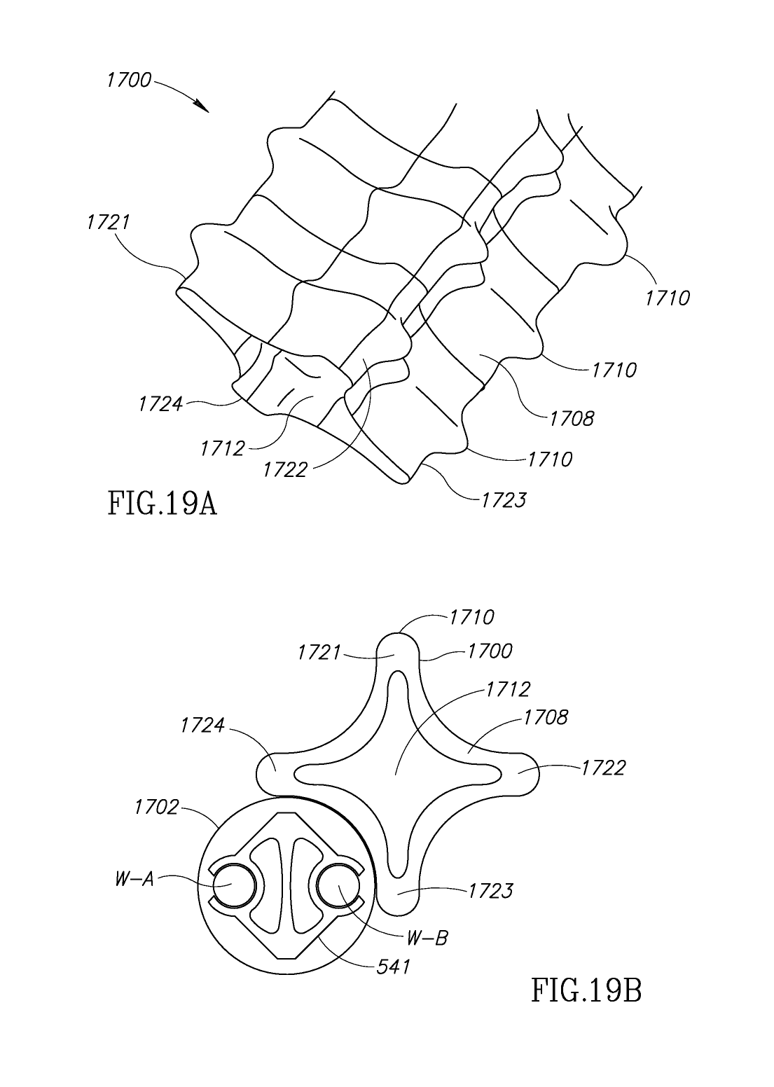

FIGS. 19A-26 each depicts an embodiment of a deformation resistant center separator. Such deformation resistant center separators each include (a) meniscus shaped (or crescent-shaped) portions that help retain the shape of the center separator against otherwise deforming forces to help maintain a generally “+” shaped cross-sectional shape and prevent transverse displacement of the dividers or vanes, and (b) air-introducing features or structures that replace solid dielectric material with air. These deformation resistant center separators may be incorporated in any of the cables described herein (e.g., the cable 10A depicted in FIG. 1A, the cable 10B depicted in FIG. 1B, the cable 100 depicted in FIG. 3A, the cable 1600 depicted in FIG. 18, and the like). Like reference numerals have been used to identify like structures in FIGS. 19A-26.

FIGS. 19A and 19B depict a first embodiment of a longitudinally elongated center separator 1700 configured to resist deformation when lateral forces are applied to the center separator 1700. FIG. 19A is a perspective view of the center separator 1700, and FIG. 19B is lateral cross-sectional view of the center separator 1700. The center separator 1700 has a generally “+” shaped lateral cross-sectional shape defined at least in part by four outwardly extending dividers or vanes 1721-1724. The center separator 1700 may be constructed from any material suitable for constructing the center separator 18 (see FIGS. 1A and 1B). However, the center separator 1700 may be un-foamed to avoid the non-uniformities introduced by the foaming process. In FIG. 19B, the center separator 1700 is illustrated alongside the central insulator 541, which is surrounded by an insulating outer covering 1702 substantially identical to the insulating outer covering 146.

An air-filled channel 1712 extends longitudinally through the center separator 1700. The air-filled channel 1712 helps reduce the dielectric constant of the center separator 1700. Thus, foaming is not needed and the problems associated with excessive foaming (e.g., “sponginess”) are avoided.

The center separator 1700 has contours (e.g., meniscus shaped or crescent-shaped portions) formed in its outer surface 1708 that define radially outwardly extending ribs 1710. The ribs 1710 help resist deformation (e.g., crushing, transverse displacement of the vanes 1721-1724, and the like). Air gaps are defined by the contours between the ribs 1710. The air-gaps may be characterized as replacing solid dielectric material with air.

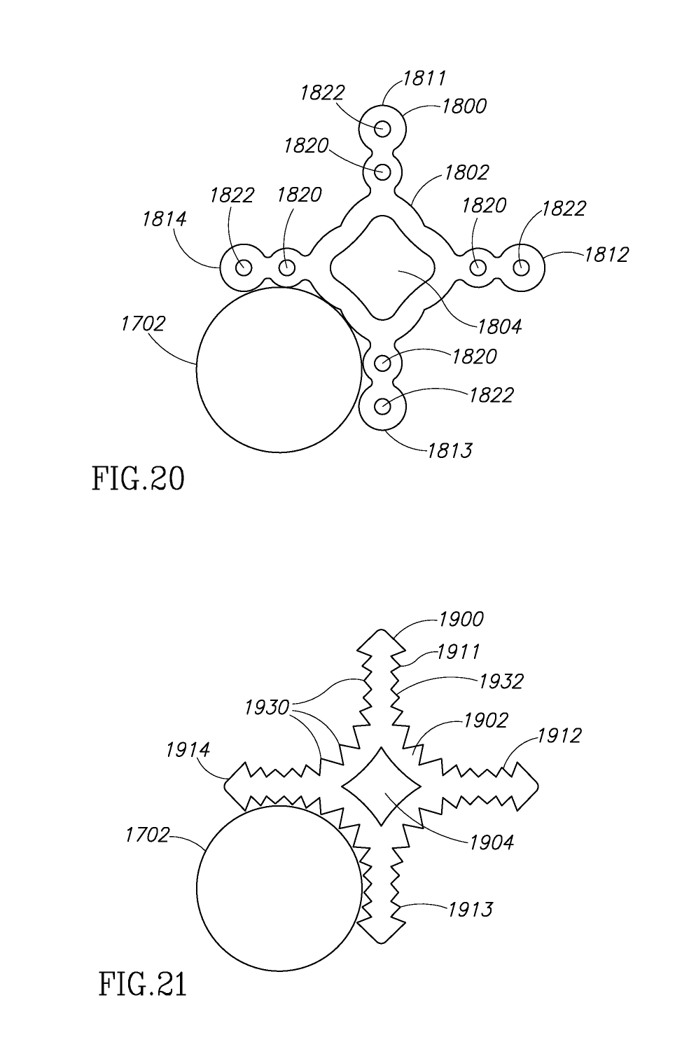

FIGS. 20-24 are lateral cross-sectional views of second, third, fourth, fifth, and sixth embodiments, respectively of the center separator 1700. As illustrated, each of these embodiments includes at least one longitudinally extending air-filled channel configured to help reduce the dielectric constant of the center separator. While not illustrated, each of these embodiments may include ribs substantially similar to the ribs 1710 illustrated in FIGS. 19A and 19B configured to help resist deformation (e.g., crushing). Such ribs may be formed by contours that are meniscus or crescent-shaped. Further, air gaps may be defined by the contours. The air gaps may be characterized as replacing solid dielectric material with air.

Turning to FIG. 20, the second embodiment is a center separator 1800 that includes a central portion 1802 in which a longitudinally extending air-filled channel 1804 is formed. Four dividers or vanes 1811-1814 extend radially outwardly from the central portion 1802. The center separator 1800 has a generally “+” shaped lateral cross-sectional shape defined at least in part by the vanes 1811-1814. Longitudinally extending air-filled channels 1820 and 1822 are formed in each of the vanes 1811-1814.

Turning to FIG. 21, the third embodiment is a center separator 1900 that includes a central portion 1902 in which a longitudinally extending air-filled channel 1904 is formed. Four dividers or vanes 1911-1914 extend radially outwardly from the central portion 1902. The center separator 1900 has a generally “+” shaped lateral cross-sectional shape defined at least in part by the vanes 1911-1914. Surface disruptions 1930 (e.g., ridges, bumps, and the like) are formed along at least a portion of an outer surface 1932 of the center separator 1900.

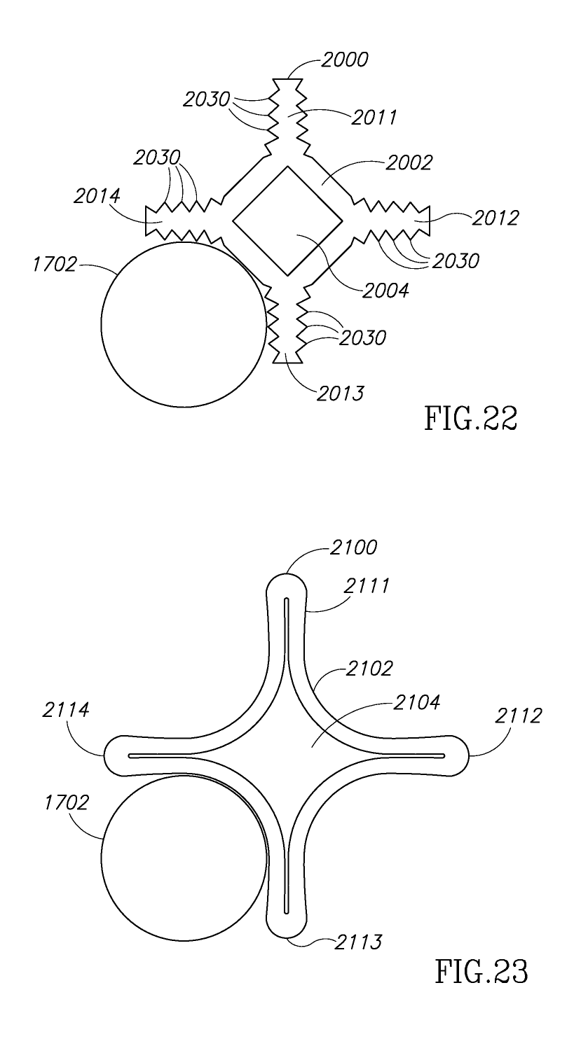

Turning to FIG. 22, the fourth embodiment is a center separator 2000 that includes a central portion 2002 in which a longitudinally extending air-filled channel 2004 is formed. Four dividers or vanes 2011-2014 extend radially outwardly from the central portion 2002. The center separator 2000 has a generally “+” shaped lateral cross-sectional shape defined at least in part by the vanes 2011-2014. Surface disruptions 2030 (e.g., ridges, bumps, and the like) are formed in each of the vanes 2011-2014.

As mentioned above, the vanes “D-1” to “D-4” of the center separator 18 illustrated in FIG. 1A are generally solid and deviate from being planar only in accordance with the cable lay. In contrast, turning to FIG. 21, the vanes 1911-1914 are not generally planar, and turning to FIG. 22, the vanes 2011-2014 are not generally planar.

Turning to FIG. 23, the fifth embodiment is a center separator 2100 that includes a central portion 2102 in which a longitudinally extending air-filled channel 2104 is formed. Four dividers or vanes 2111-2114 extend radially outwardly from the central portion 2102. The center separator 2100 has a generally “+” shaped lateral cross-sectional shape defined at least in part by the vanes 2111-2114. The air-filled channel 2104 extends outwardly radially at least partially into each of the vanes 2111-2114.

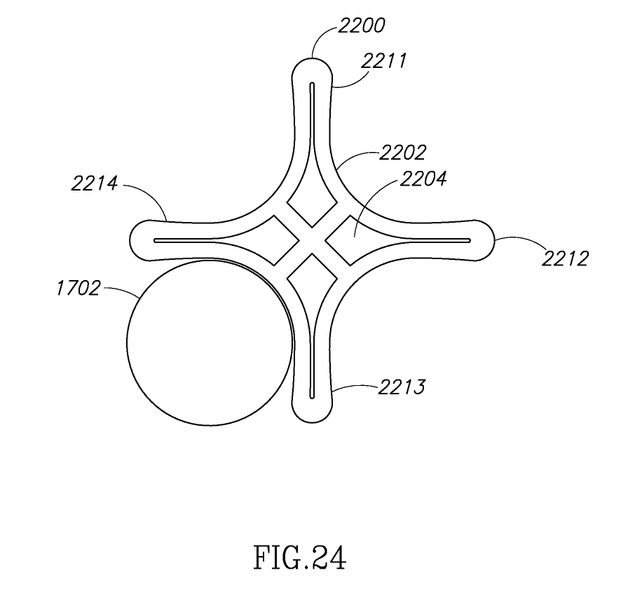

Turning to FIG. 24, the sixth embodiment is a center separator 2200 that includes a central portion 2202 in which a longitudinally extending air-filled channel 2204 is formed. Four dividers or vanes 2211-2214 extend radially outwardly from the central portion 2202. The center separator 2200 has a generally “+” shaped lateral cross-sectional shape defined at least in part by the vanes 2211-2214. The air-filled channel 2204 extends outwardly radially at least partially into each of the vanes 2211-2214. The air-filled channel 2204 is subdivided by a longitudinally extending support lattice 2230.

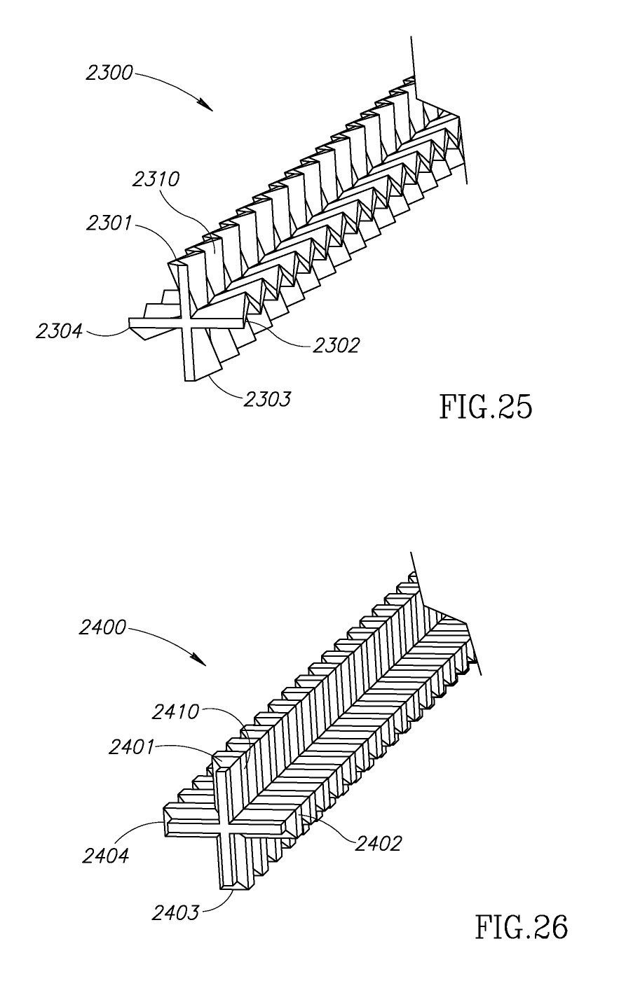

FIGS. 25 and 26 are perspective views of seventh and eighth embodiments, respectively of the center separator 1700. These embodiments may be characterized as being twisted and/or ruffled. Optionally, each of these embodiments may include at least one longitudinally extending air-filled channel (not shown) configured to help reduce the dielectric constant of the center separator.

The center separator 18 illustrated in FIG. 1A has the four outwardly extending dividers or vanes “D-1” to “D-4.” As mentioned above, the vanes “D-1” to “D-4” are generally solid and deviate from being planar only in accordance with the cable lay. In contrast, as seen in FIG. 25, vanes 2301-2304 of the seventh embodiment of a center separator 2300 and as seen in FIG. 26, vanes 2401-2404 of the seventh embodiment of a center separator 2400 are not generally planar.

Turning to FIG. 25, the pattern embossed in an outside surface 2310 of the center separator 2300 gives the center separator 2300 the appearance of having been twisted repeated clockwise and counterclockwise less than 360 degrees. Optionally, the twisting may have a higher frequency than the cable lay. The twisting forms longitudinally extending repeating patterns in each of the vanes 2301-2304 that help resist deformation (e.g., crushing). The center separator 2300 has a generally “+” shaped lateral cross-sectional shape defined at least in part by the vanes 2301-2304.

Turning to FIG. 26, the pattern embossed in an outside surface 2410 of the center separator 2400 gives the center separator 2400 the appearance of having a ruffled or ribbed outside surface. The center separator 2400 has a generally “+” shaped lateral cross-sectional shape defined at least in part by the vanes 2401-2404.

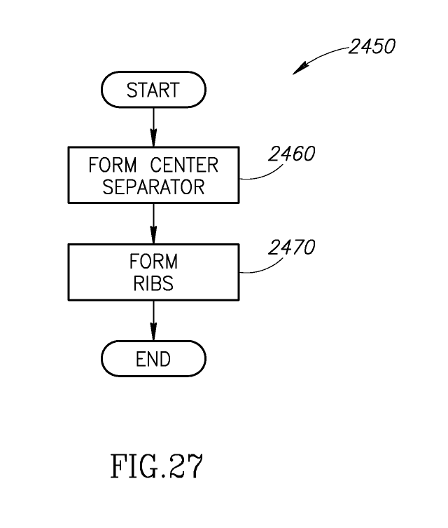

FIG. 27 is a flow diagram of a method 2450 of forming a deformation resistant center separator (e.g., the center separator 1700 depicted in FIGS. 19A and 19B). For ease of illustration, the method 2450 will be described with respect to the center separator 1700. However, the method 2450 may be used with any of the deformation resistant center separator depicted in FIGS. 19A-26. In first block 2460, the center separator 1700 is formed (e.g., by a conventional extrusion process known to those of ordinary skill in the art as suitable for forming center separators). Then, in block 2470, the ribs 1710 (or other surface disruptions or features) are formed in the center separator 1700. By way of a non-limiting example, the ribs 1710 maybe embossed or otherwise molded or pressed into the center separator 1700. Then, the method 2450 terminates. Thus, the center separator 1700 may be constructed by first extruding the center separator 1700 and then embossing outer contours on the center separator 1700 to define the radially outwardly extending ribs 1710.

### Center Separator with Reduced Effective Dielectric Constant

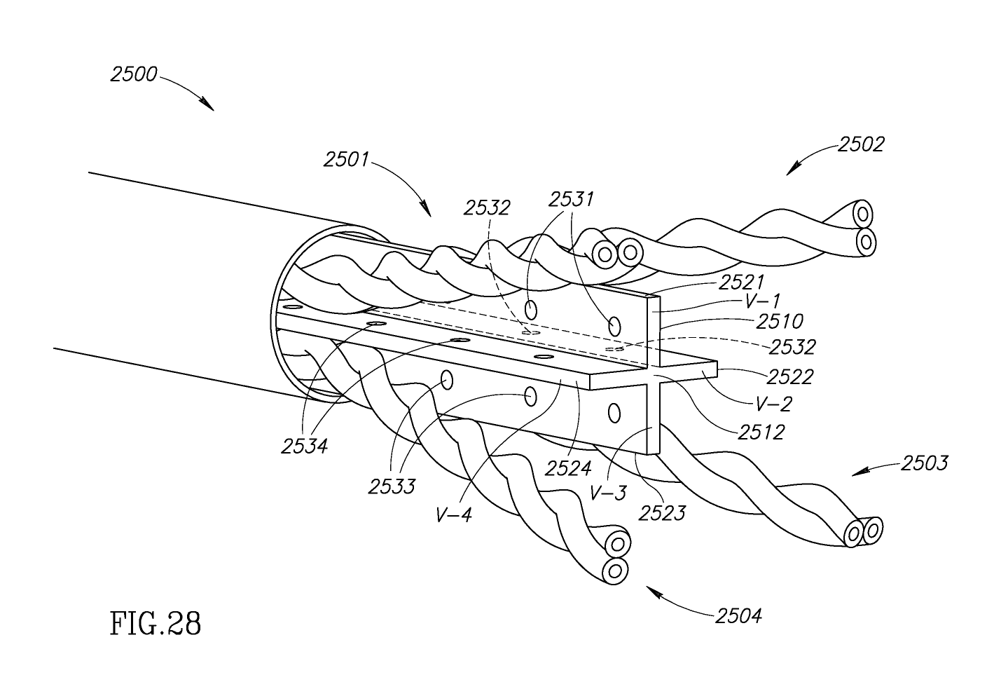

FIG. 28 is a perspective view of a cable 2500 that includes wire pairs 2501-2504, and a filler or center separator 2510. The wire pairs 2501-2504 are substantially similar to the wire pairs “P-1” to “P-4,” respectively, depicted in FIG. 1A.

Turning to FIG. 28, the center separator 2510 has a lower overall dielectric constant and dissipation factor than a conventional center separator (e.g., the center separator 18 depicted in FIG. 1A). Further, the center separator 2510 does not need to be foamed and can be constructed from PE or other conventional insulating materials, such as FRPE, XLPE, FEP, other fluoropolymers, combinations thereof, and the like. As with the central insulators 140, and the central separator 160, XLPE may be used to construct the central separator 2510 because of its desirable mechanical properties.

While the center separator 2510 illustrated has a generally cross-shaped cross sectional shape. This is not a requirement. Through the application of ordinary skill in the art to the present teachings, center separators having different shapes may be constructed. By way of non-limiting examples, the shapes depicted in FIGS. 19A-26 may be used to construct the center separator 2510.

In the embodiment illustrated, the center separator 2510 includes a plurality of vanes “V-1” to “V-4.” The vanes “V-1” to “V-4” are connected together at a center portion 2512. Opposite, the center portion 2512, the vanes “V-1” to “V-4” have distal edge portions 2521-2524, respectively. The vane “V-1” is opposite the vane “V-3” and the vain “V-2” is opposite the vane “V-4.” The vane “V-1” is substantially coplanar with the vane “V-3.” The vane “V-2” is substantially coplanar with the vane “V-4.” Further, the vanes “V-1” and “V-3” are substantially orthogonal to the vanes “V-2” and “V-4.”

The center separator 2510 includes a first plurality of through-holes 2531 distributed longitudinally along the vane “V-1,” a second plurality of through-holes 2532 distributed longitudinally along the vane “V-2,” a third plurality of through-holes 2533 distributed longitudinally along the vane “V-3,” and a fourth plurality of through-holes 2534 distributed longitudinally along the vane “V-4.” The through-holes 2531-2534 are filled with air, which has a dielectric constant of about 1.0, which is less than the dielectric constant of the material used to construct the center separator 2510. For example, the material used to construct the center separator 2510 may have a dielectric constant of about 2.1 to about 3.0. Thus, the through-holes 2531-2534 reduce the dielectric constant and dissipation factor of the center separator 2510. Because the through-holes 2531-2534 reduce the overall dielectric constant of the center separator 2510, the overall effective dielectric constant seen by the wire pairs 2501-2504 is also reduced.

The through-holes 2531-2534 illustrated in the drawings have a circular cross-sectional shape. However, this is not a requirement. By way of other non-limiting examples, the through-holes 2531-2534 may have other cross-sectional shapes, such as square, rectangular, triangular, oval, arbitrary, etc. Further, the through-holes 2531-2534 need not all have the same cross-sectional shape.

The through-holes 2531-2534 may be characterized as extending laterally through the vanes “V-1” to “V-4.”

In the embodiment illustrated, the through-holes 2531-2534 are formed in the vanes “V-1” to “V-4.” At least a portion of one or more of the through-holes 2531-2534 may be formed in the distal edge portions 2521-2524 of the vanes “V-1” to “V-4,” respectively. It may be desirable to space longitudinally the through-holes 2531 and 2533 formed in the vanes “V-1” and “V-3,” respectively, from the through-holes 2532 and 2534 formed in the vanes “V-2” and “V-4,” respectively. For example, the through-holes 2531 and 2533 may be formed in the vanes “V-1” and “V-3,” respectively, at first locations. Then, the through-holes 2532 and 2534 formed in the vanes “V-2” and “V-4,” respectively, at second locations that are spaced apart longitudinally from first locations. Thus, the through-holes 2531 and 2533 formed in the vanes “V-1” and “V-3,” respectively, are not aligned with the through-holes 2532 and 2534 formed in the vanes “V-2” and “V-4,” respectively, to avoid decreasing the lateral crush resistance of the center separator 2510. The through-holes 2531 and 2533 formed in the vanes “V-1” and “V-3,” respectively, may be alternated (e.g., in a repeating pattern) with the through-holes 2532 and 2534 formed in the vanes “V-2” and “V-4,” respectively. Thus, the through-holes 2532 and 2534 may be offset longitudinally from the through-holes 2531 and 2533.

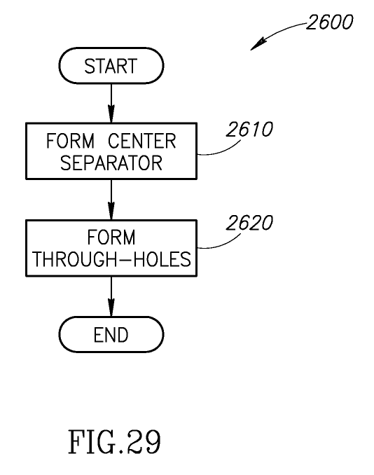

FIG. 29 is a flow diagram of a method 2600 of forming the center separator 2510. In first block 2610, the center separator 2510 is formed (e.g., by a conventional extrusion process known to those of ordinary skill in the art as suitable for forming center separators). Then, in block 2620, the through-holes 2531-2534 are formed in the center separator 2510. The through-holes 2531-2534 may be formed by a cutting process, a boring process, a punching process, a stamping process, a combination thereof, and the like.

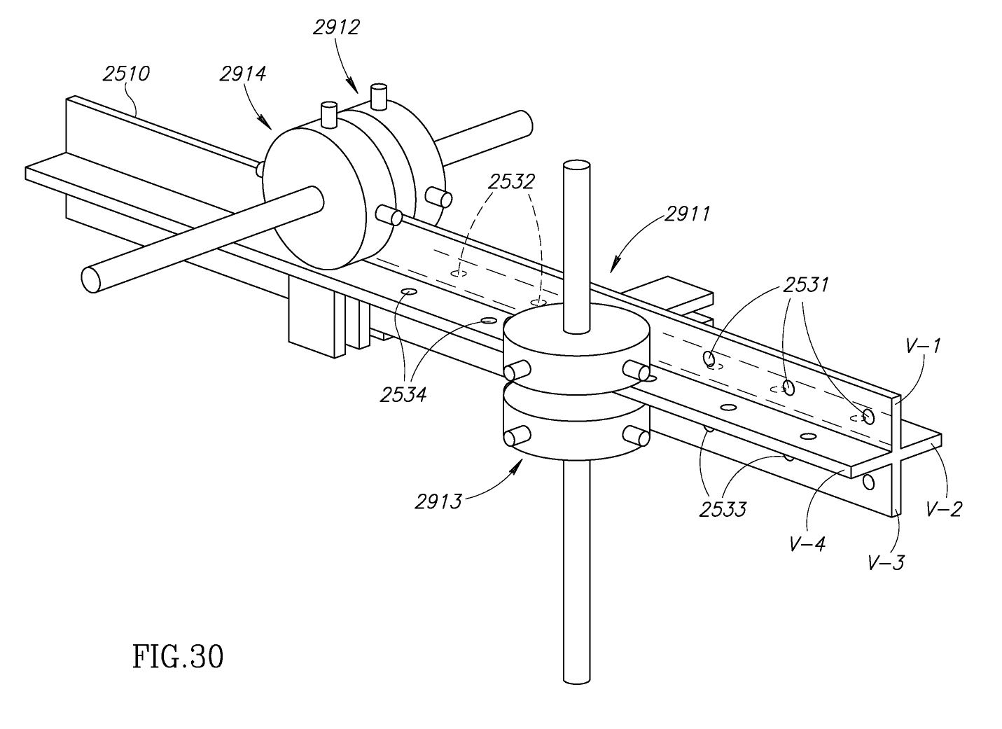

Turning to FIG. 30, by way of a non-limiting example, the through-holes 2531-2534 may be formed in the vanes “V-1” to “V-4,” respectively, using a series of rotating tool and die assemblies 2911-2914. In the embodiment illustrated, the four tool and die assemblies 2911-2914 are used. The first tool and die assembly 2911 forms the through-holes 2531 in the vane “V-1.” The second tool and die assembly 2912 forms the through-holes 2532 in the vane “V-2.” The third tool and die assembly 2913 forms the through-holes 2533 in the vane “V-3.” The fourth tool and die assembly 2914 forms the through-holes 2534 in the vane “V-4.”

Optionally, the tool and die assemblies 2911 and 2913 may be adjacent one another and used to form simultaneously the through-holes 2531 and 2533 in the vanes “V-1” and “V-3,” respectively. Optionally, the tool and die assemblies 2912 and 2914 may be adjacent one another and used to form simultaneously the through-holes 2532 and 2534 in the vanes “V-2” and “V-4,” respectively. The tool and die assemblies 2911 and 2913 may be spaced apart longitudinally from the tool and die assemblies 2912 and 2914 along the center separator 2510.

Then, returning to FIG. 29, the method 2600 terminates.

Blocks 2610 and 2620 of the method 2600 may be performed “inline.” In such embodiments, the through-holes 2531-2534 are formed immediately after the center separator 2510 is formed (e.g., extruded). Alternatively, blocks 2610 and 2620 may be performed “offline.” In such embodiments, after the center separator 2510 is formed (e.g., extruded), the through-holes 2531-2534 are formed at a later time (and optionally at a different physical location). In any event, the equipment used to form the center separator 2510, may be similar to equipment typically used to construct conventional center separators (such as the center separator 18 depicted in FIG. 1A). However, this is not a requirement.

Returning to FIG. 28, by way of a non-limiting example, the through-holes 2531-2534 may be spaced apart (center-to-center) along the vanes “V-1” to “V-4,” respectively, approximately 0.25 inches to approximately 0.75 inches. The through-holes 2531-2534 may have any shape or size, but are configured to preserve the mechanical stability (e.g., lateral crush resistance) of the center separator 2510 so that the center separator 2510 is configured to maintain physical separation of the wire pairs 2501-2504 from one another. As mentioned above, the through-holes 2531 and 2533 formed in the vanes “V-1” and “V-3,” respectively, are not aligned with the through-holes 2532 and 2534 formed in the vanes “V-2” and “V-4” to avoid decreasing the lateral crush resistance of the center separator 2510. The through-holes 2531 and 2533 formed in the vanes “V-1” and “V-3,” respectively, may be alternated with the through-holes 2532 and 2534 formed in the vanes “V-2” and “V-4,” respectively. This alternating pattern may help maintain the physical stability of the center separator 2510 along the length of the center separator 2510.

As is apparent to those of ordinary skill in the art, the center separator 2510 may be incorporated into any of the cables disclosed herein (e.g., the cable 10A depicted in FIG. 1A, the cable 10B depicted in FIG. 1B, the cable 100 depicted in FIG. 3A, the cable 1600 depicted in FIG. 18, and the like). Further, turning to FIG. 17A, through-holes (not shown) substantially similar to the through-holes 2531 (see FIG. 28) may be formed in the center separator 1560 of the cable 1500.

### Coaxial Cable

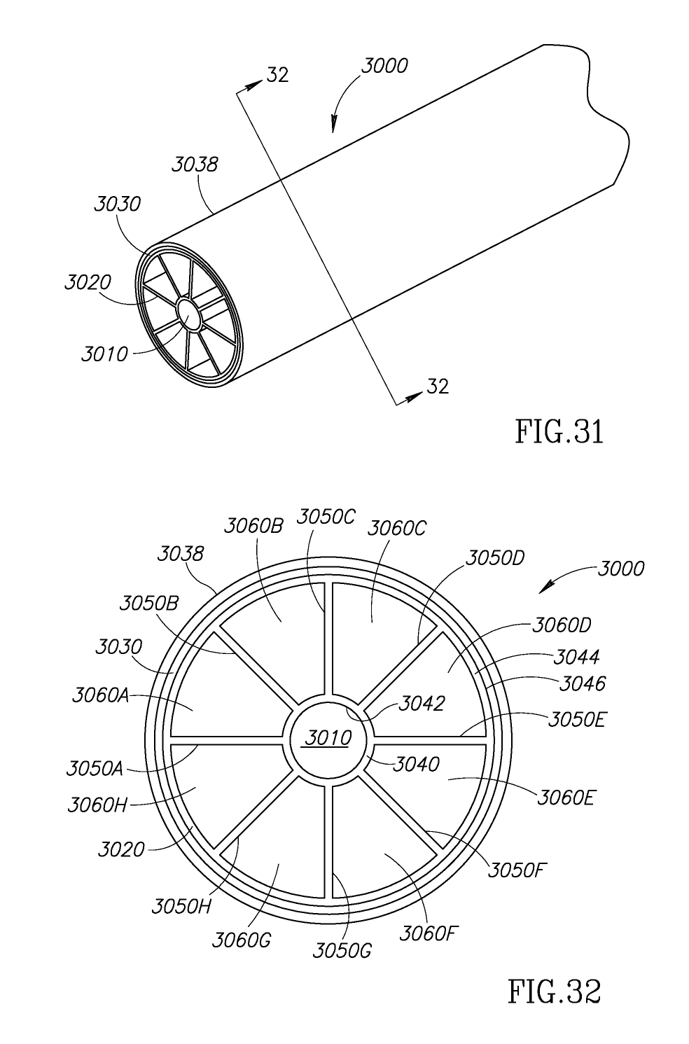

FIG. 31 is a perspective view of a coaxial cable 3000. FIG. 32 is a lateral cross-sectional view of the coaxial cable 3000 taken through a line 32-32 depicted in FIG. 31. The cable 3000 includes a conventional wire-shaped central conductor 3010, a central insulator 3020, a conventional hollow cylindrically shaped outer conductor 3030, and a conventional insulating cable jacket 3038. As is apparent to those of ordinary skill in the art, the central conductor 3010 and the outer conductor 3030 may be used to transmit single ended, unbalanced, signals.

Turning to FIG. 32, the central insulator 3020 is positioned between the central conductor 3010 and the outer conductor 3030. The central insulator 3020 includes a cylindrically shaped inner wall 3040 defining a central channel 3042 configured to house the central conductor 3010. Thus, the inner wall 3040 may be characterized as being a central housing for the central conductor 3010.

The central insulator 3020 includes a cylindrically shaped outer wall 3044 positioned alongside the outer conductor 3030. The outer wall 3044 defines a peripheral portion 3046 of the central insulator 3020. While illustrated as extending continuously along the inside of the hollow cylindrically shaped outer conductor 3030, this is not a requirement. In alternate embodiments (not shown), the outer wall 3044 may be discontinuous and extend along only a portion of the inside of the outer conductor 3030. By way of a non-limiting example, contours (not shown), such as meniscus or crescent shaped contours, may be formed in the outer wall 3044 so that air-filled gaps (not shown) are defined between the outer wall 3044 and the outer conductor 3030. By way of another non-limiting example, ribs (not shown), projections (not shown), recesses (not shown), through-holes (not shown), and/or other surface disruptions (not shown) may be formed in the outer wall 3044

A plurality of longitudinally elongated supports 3050A-H extend radially outwardly from the inner wall 3040 to the outer wall 3044. Thus, the central insulator 3020 may be characterized as having a generally wagon-wheel shaped lateral cross-sectional shape. The supports 3050A-H are configured (e.g., sufficiently stiff and resilient) to help maintain a desired radial distance between the central conductor 3010 and the outer conductor 3030. As is apparent to those of ordinary skill in the art, it is desirable to maintain the central conductor 3010 at the center of the outer conductor 3030 at all points along the length of the cable 3000. While the supports 3050A-H are illustrated as extending continuously in the longitudinal direction, this is not a requirement. In alternate embodiments (not shown), the supports 3050A-H may be discontinuous in the longitudinal direction. Further, the shape and size of the supports 3050A-H may vary along the cable 3000 in the longitudinal direction. For example, ribs (not shown), projections (not shown), recesses (not shown), through-holes (not shown), and/or other surface disruptions (not shown) may be formed in one or more of the supports 3050A-H. By way of another non-limiting example, contours (not shown), such as meniscus or crescent shaped contours, may be formed laterally in the supports 3050A-H.

Air-filled spaces 3060A-H are defined between the supports 3050A-H, the inner wall 3040, and the outer wall 3044. The air-filled spaces 3060A-H may be described as having a generally pie-shaped cross-sectional shape. In the embodiment illustrated, the air-filled space 3060A is defined between the support 3050A, the support 3050B, the inner wall 3040, and the outer wall 3044. The air-filled space 3060B is defined between the support 3050B, the support 3050C, the inner wall 3040, and the outer wall 3044. The air-filled space 3060C is defined between the support 3050C, the support 3050D, the inner wall 3040, and the outer wall 3044. The air-filled space 3060D is defined between the support 3050D, the support 3050E, the inner wall 3040, and the outer wall 3044. The air-filled space 3060F is defined between the support 3050F, the support 3050G, the inner wall 3040, and the outer wall 3044. The air-filled space 3060G is defined between the support 3050G, the support 3050H, the inner wall 3040, and the outer wall 3044. The air-filled space 3060H is defined between the support 3050H, the support 3050A, the inner wall 3040, and the outer wall 3044.

The central insulator 3020 may be constructed from an insulating material, such as PE, XLPE, FRPE, FEP, other fluoropolymers, combinations thereof, and the like. XLPE may be used to construct the central insulator 3020 because XLPE has desirable mechanical properties. Further, the central insulator 3020 may be un-foamed to avoid the non-uniformities introduced by the foaming process. However, this is not a requirement. The central insulator 3020 may be constructed using a conventional extrusion process known to those of ordinary skill in the art as suitable for forming center separators.

The central conductor 3010 may be coextruded with the central insulator 3020 or installed therein at a later time. In embodiments in which the central conductor 3010 is installed in the central insulator 3020 after the central insulator 3020 has been extruded, the central insulator 3020 may include one or more longitudinally extending openings (not shown) formed in the inner wall 3040 and/or the outer wall 3044 through which the central conductor 3010 may pass to enter and be positioned inside the central channel 3042. For example, the inner wall 3040 may include a first longitudinally extending opening (not shown) through which the central conductor 3010 may pass laterally to be received inside the central channel 3042. The outer wall 3044 may include a second longitudinally extending opening (not shown) through which the central conductor 3010 may pass laterally to subsequently enter the first opening (not shown) formed in the inner wall 3040. The first and second openings may be aligned with one another radially. However, this is not a requirement. In embodiments that include the first opening, the inner wall 2040 is discontinuous. In embodiments that include the second opening, the outer wall 3044 is discontinuous. After the central conductor 3010 is positioned inside the central channel 3042, the central insulator 3020 may be positioned inside the outer conductor 3030.

A hinge (not shown) may be defined in a portion of the outer wall 3044 (e.g., a portion of the outer wall 3044 opposite the second opening (not shown)). The first and second openings (not shown) formed in the inner and outer walls 3040 and 3044, respectively, may be enlarged by bending the central insulator 3020 at the hinge (not shown) in an opening direction. Then, after the central conductor 3010 is positioned inside the central channel 3042, the central insulator 3020 may be bent at the hinge (not shown) in a closing direction opposite the opening direction to close (or reduce the size of) the first and second openings (not shown). After the first and second openings (not shown) have been closed, the central insulator 3020 may be positioned inside the outer conductor 3030.

Optionally, the central insulator 3020 may be separable into two or more separate pieces. In such embodiments, the inner wall 3040 may include two or more longitudinally extending openings (not shown) and the outer wall 3044 may include two or more longitudinally extending openings (not shown) positioned such that the central insulator 3020 is separable into two or more separate pieces (not shown). When the pieces (not shown) are separated, the central conductor 3010 may be positioned inside the central channel 3042 and the pieces (not shown) reassembled. The reassembled pieces (not shown) may be positioned inside the outer conductor 3030.

Optionally, longitudinally extending snap-fit connectors (not shown) may be formed in the edges (not shown) of the inner wall 3040 that define an opening (not shown) in the inner wall 3040. Thus, a pair of longitudinally extending snap-fit connectors (not shown) may flank each of the longitudinally extending openings (not shown) formed in the inner wall 3040. The longitudinally extending snap-fit connectors (not shown) may be used to close the opening (not shown) flanked by the connectors. For example, the edges (not shown) of the inner wall 3040 that define a particular opening (not shown) in the inner wall 3040 may be pressed together to snap the snap-fit connector together and close the particular opening. Conversely, the edges (not shown) of the inner wall 3040 that define the particular opening (not shown) in the inner wall 3040 may be pulled apart to unsnap the snap-fit connector and open the particular opening.

Optionally, longitudinally extending snap-fit connectors (not shown) may be formed in the edges (not shown) of the outer wall 3044 that define an opening (not shown) in the outer wall 3044. Thus, a pair of longitudinally extending snap-fit connectors (not shown) may flank each of the longitudinally extending openings (not shown) formed in the outer wall 3044. The longitudinally extending snap-fit connectors (not shown) may be used to close the opening (not shown) flanked by the connectors. For example, the edges (not shown) of the outer wall 3044 that define a particular opening (not shown) in the outer wall 3044 may be pressed together to snap the snap-fit connector together and close the particular opening. Conversely, the edges (not shown) of the outer wall 3044 that define the particular opening (not shown) in the outer wall 3044 may be pulled apart to unsnap the snap-fit connector and open the particular opening.

The central insulator 3020 may be coextruded with the outer conductor 3030 or installed therein at a later time. For example, the central insulator 3020 may be coextruded with both the outer conductor 3030 and the central conductor 3010 at the same time.

The insulating cable jacket 3038 may be disposed about the outer conductor 3030 using any method known in the art for wrapping an outer conductor of a coaxial cable in an insulating cable jacket.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A central insulator for use with a first wire and a second wire, the first wire and the second wire forming a wire pair configured to carry a differential signal, the central insulator comprising:
an elongated first wire channel having a longitudinally extending opening configured to receive the first wire into the first wire channel;
an elongated second wire channel having a longitudinally extending opening configured to receive the second wire into the second wire channel, the second wire channel being spaced apart laterally from the first wire channel; and
an intermediate portion positioned between the first and second wire channels.

2. The central insulator of claim 1, wherein the intermediate portion comprises at least one longitudinally extending air-filled channel at least partially positioned between the first and second wire channels, the air-filled channel being spaced part from both the first and the second wire channels.

3. The central insulator of claim 1, wherein the intermediate portion comprises a longitudinally extending center support flanked by a first longitudinally extending air-filled channel and a second longitudinally extending air-filled channel, the first air-filled channel being positioned between the center support and the first wire channel, and the second air-filled channel being positioned between the center support and the second wire channel.

4. The central insulator of claim 1, wherein the intermediate portion comprises a plurality of longitudinally extending air-filled channels, at least a portion of which being defined between a plurality longitudinally extending lateral support members.

5. The central insulator of claim 1, wherein the intermediate portion comprises a longitudinally extending support lattice at least partially defining a plurality longitudinally extending interstitial spaces.

6. The central insulator of claim 1, wherein the first and second wire channels arrange the first and second wires in a twisted wire arrangement.

7. A cable comprising:
a first wire;
a second wire;
a third wire, together the first, second, and third wires forming a first wire trio configured to conduct a three-phase signal comprising two communication channels;
a fourth wire;
a fifth wire; and
a sixth wire, together the fourth, fifth, and sixth wires forming a second wire trio configured to conduct a three-phase signal comprising two communication channels.

8. The cable of claim 7, further comprising:
a first elongated central insulator having a first, second, and third longitudinally extending wire channel, the first, second and third wires being positioned inside the first, second, and third wire channels, respectively; and
a second elongated central insulator having a fourth, fifth, and sixth longitudinally extending wire channel, the fourth, fifth, and sixth wires being positioned inside the fourth, fifth, and sixth wire channels, respectively.

9. The cable of claim 8, wherein the first central insulator comprises at least one first longitudinally extending air-filled channel positioned between the first, second, and third wire channels, the at least one first air-filled channel being discontinuous with each of the first, second, and third wire channels, and
the second central insulator comprises at least one second longitudinally extending air-filled channel positioned between the fourth, fifth, and sixth wire channels, the at least one second air-filled channel being discontinuous with each of the fourth, fifth, and sixth wire channels.

10. The cable of claim 7, further comprising:
a center separator positioned between the first and second wire trios.

11. The cable of claim 10, wherein the center separator comprises a plurality of through-holes formed therein.

12. The cable of claim 7, further comprising:
a third wire trio configured to conduct a three-phase signal comprising two communication channels;
a fourth wire trio configured to conduct a three-phase signal comprising two communication channels; and
a center separator positioned between the first, second, third, and fourth wire trios.

13. The cable of claim 12, wherein the center separator comprises a plurality of through-holes formed therein.

14. An elongated center separator for use with four wire pairs, the center separator comprising:
a longitudinally extending central portion comprising an air-filled longitudinally extending channel;
a first portion extending outwardly from the central portion, the first portion being positionable between a first of the wire pairs and a second of the wire pairs;
a second portion extending outwardly from the central portion, the second portion being positionable between the second wire pair and a third of the wire pairs;
a third portion extending outwardly from the central portion, the third portion being positionable between the third wire pair and a fourth of the wire pairs; and
a fourth portion extending outwardly from the central portion, the fourth portion being positionable between the fourth wire pair and the first wire pair.

15. The center separator of claim 14, further comprising:
an outer surface comprising a plurality of surface disruptions.

16. The center separator of claim 15, wherein the plurality of surface disruptions comprise outwardly extending ribs formed at least partially in the first, second, third, and fourth portions.

17. The center separator of claim 14, wherein at least one of the first, second, third, and fourth portions comprises a plurality of laterally extending through-holes.

18. The center separator of claim 14, wherein at least one of the first, second, third, and fourth portions comprises a longitudinally extending air-filled channel.

19. A method of forming an elongated center separator for use with two or more wire pairs, the method comprising:
extruding the center separator; and
forming at least one of surface disruptions and through-holes in the extruded center separator.

20. The method of claim 19, wherein the at least one of surface disruptions and through-holes comprises a plurality of surface disruptions formed by embossing.

21. The method of claim 19, wherein the at least one of surface disruptions and through-holes comprises a plurality of surface disruptions, and
the plurality of surface disruptions comprises outwardly extending ribs.

22. The method of claim 19, wherein the at least one of surface disruptions and through-holes comprises both a plurality of surface disruptions and a plurality of through-holes.

23. The method of claim 19, wherein the at least one of surface disruptions and through-holes comprises a plurality of through-holes formed by punching the plurality of through-holes into the extruded center separator.

24. The method of claim 19, wherein the at least one of surface disruptions and through-holes comprises a plurality of through-holes;
the extruded center separator comprises a plurality of outwardly extending vanes;
each vane is positionable between a different adjacent pair of the two or more wire pairs; and
the plurality of through-holes are formed in the vanes.

25. An elongated center separator for use with four wire pairs, the center separator comprising:
a longitudinally extending central portion;
a first vane extending outwardly from the central portion, the first vane being positionable between a first of the wire pairs and a second of the wire pairs;
a second vane extending outwardly from the central portion, the second vane being positionable between the second wire pair and a third of the wire pairs;
a third vane extending outwardly from the central portion, the third vane being positionable between the third wire pair and a fourth of the wire pairs; and
a fourth vane extending outwardly from the central portion, the fourth vane being positionable between the fourth wire pair and the first wire pair, wherein at least one of the first, second, third, and fourth vanes comprises a plurality of laterally extending through-holes.

26. An elongated center separator for use with a wire-shaped central conductor and a hollow cylindrically shaped outer conductor of a coaxial cable, the center separator comprising:
a central housing configured to house the wire-shaped central conductor of the coaxial cable;
an outer peripheral portion positionable inside the hollow cylindrically shaped outer conductor of the coaxial cable;
a plurality of radially extending supports, each of the supports extending between the central housing and the outer peripheral portion; and
a plurality of air-filled gaps defined between adjacent ones of the radially extending supports.

27. The center separator of claim 26, wherein the center separator is configured to be coextruded with the central conductor.

28. The center separator of claim 26, wherein the center separator is configured to be coextruded with both the central conductor and the outer conductor.

29. The center separator of claim 26, wherein the central housing comprises a central channel defined by a cylindrically shaped inner wall, the central channel being configured to house the wire-shaped central conductor of the coaxial cable.

30. The center separator of claim 29, wherein the inner wall includes a longitudinally extending opening through which the wire-shaped central conductor of the coaxial cable may be inserted laterally into the central channel.

31. The center separator of claim 30, wherein the outer peripheral portion includes a longitudinally extending opening through which the wire-shaped central conductor of the coaxial cable may be inserted laterally to be received inside the opening in the inner wall.

32. The center separator of claim 26, wherein the center separator is constructed from at least one of polyethylene, cross-linked polyethylene, flame retardant polyethylene, fluorinated ethylene propylene, and a fluoropolymer.
